(19) United States
(12) Patent Application Publication
(10) Pub. No.: US 2023/0164298 A1
(43) Pub. Date: May 25, 2023

(54) GENERATING AND MODIFYING VIDEO CALLING AND EXTENDED-REALITY ENVIRONMENT APPLICATIONS

(71) Applicant: Meta Platforms, Inc., Menlo Park, CA (US)

(72) Inventors: Ishan Sanjay Khot, Seattle, WA (US); Hani Mohamad Atassi, Sammamish, WA (US); Eduardo Munoz Ibanez, New York, NY (US); Alice Yi Meng, Bellevue, WA (US); Rochelle Malia Willard, Seattle, WA (US); Valentina Igorevna Kozina, Seattle, WA (US); Adam Hill, Brier, WA (US); Cameron James Pickett, Seattle, WA (US); Wing Mei Cheramie Cheung, Menlo Park, CA (US); Marcus Vinicius Barbosa da Silva, San Francisco, CA (US); Bhabani Panda, Maidenhead (GB); Mitesh Dave, San Diego, CA (US); Arpit Mehta, Piscataway, NJ (US); Azam Jiva, Richmond, TX (US); Dalia Antoinette Del Rio Lazo, Seattle, WA (US); Emmett Dzieza, Berkeley, CA (US); David Marc Cohen, Truckee, CA (US)

(21) Appl. No.: 18/068,260

(22) Filed: Dec. 19, 2022

Related U.S. Application Data
(60) Provisional application No. 63/378,349, filed on Oct. 4, 2022.
(60) Provisional application No. 63/375,817, filed on Sep. 15, 2022.
(60) Provisional application No. 63/370,763, filed on Aug. 8, 2022.
(60) Provisional application No. 63/291,848, filed on Dec. 20, 2021.

(51) Int. Cl. H04N 7/15; H04N 7/14; G06T 13/40; G06T 19/00; G06Q 20/12

(52) U.S. Cl. CPC H04N 7/157; H04N 7/147; H04N 7/152; G06T 13/40; G06T 19/006; G06Q 20/123

(57) ABSTRACT

Systems, methods, client devices, and non-transitory computer-readable media are disclosed for generating, updating, and otherwise managing video calling applications utilizing an adaptive video calling library architecture. For example, the disclosed systems can store a set of core video calling functions in a function repository. Indeed, the disclosed systems can store and manage additional video calling functions that are addable to the core video calling functions as part of a video calling application. Moreover, the disclosed systems can encode video calling functions that enable video calls which facilitate augmented reality background environments. Additionally, the disclosed systems can implement functions that enable secure payment transactions through a secure voice channel between a user operating within an extended-reality environment and another user within a real-world environment. Moreover, the disclosed systems can implement functions that render animated avatars utilizing visemes identified from audio data captured by a client device during a video call.

### CROSS-REFERENCE TO RELATED APPLICATIONS

This present application claims the benefit of, and priority to U.S. Provisional Application No. 63/378,349, entitled “ANIMATING AVATARS UTILIZING AUDIO-BASED VISEME RECOGNITION,” filed Oct. 4, 2022, U.S. Provisional Application No. 63/375,817, entitled “FACILITATING PAYMENT TRANSACTIONS OVER A VOICE CHANNEL WITHIN EXTENDED-REALITY ENVIRONMENTS,” filed Sep. 15, 2022, U.S. Provisional Application No. 63/370,763, entitled “PROVIDING AUGMENTED REALITY ENVIRONMENTS WITHIN VIDEO CALLS,” filed Aug. 8, 2022, and U.S. Provisional Application No. 63/291,848, entitled “GENERATING AND MODIFYING VIDEO CALLING APPLICATIONS UTILIZING AN ADAPTIVE VIDEO CALLING LIBRARY ARCHITECTURE,” filed Dec. 20, 2021. The aforementioned provisional applications are hereby incorporated by reference in their entireties.

### BACKGROUND

Advancements in software and hardware platforms have led to a variety of improvements in systems that connect users within a social network. For example, digital communication systems are now able to provide video calls between devices so that users can communicate with each other face-to-face over long distances. Some digital communication systems have been developed that enable groups of more than two devices to connect within a common video conference. Despite these advances however, conventional digital communication systems continue to suffer from a number of disadvantages, particularly in their efficiency, speed, and flexibility.

As just mentioned, some existing systems inefficiently utilize computing resources such as processing power, processing time, and memory in storing, managing, and updating video calling applications. To elaborate, many conventional digital communication systems store excessively large video calling applications that include inefficient encodings for video calling functions, some of which are unused. As these existing systems update and modify video calling applications over time (e.g., to add new features, fix bugs, etc.), the video calling applications continue to balloon in size, often including inefficient encodings for video calling functions as systems attempt to keep old functions working along with new ones. These inefficiencies are magnified in cases where existing systems store many variations of a video calling application for different platforms, different geographic regions, different client devices (e.g., client devices of varying capability), each with their own set of video calling functions. The inefficiency of conventional systems becomes especially problematic for size-constrained platforms (e.g., servers with limited capacity and/or client devices with limited capability) that require lighter, leaner versions of a video calling application.

Relating to (and sometimes caused by) their inefficiency, some conventional digital communication systems are also slow. For instance, some conventional systems are sluggish at loading, updating, and initializing video calling applications. More specifically, due at least in part to the excessive size of video calling applications maintained by conventional systems, the cumbersome size of these applications therefore requires extra computing time and computing power to perform application updates, downloads, or startups at the server and/or the client device. The excess computing time and power required by existing systems further leads to delays and slowdowns that are otherwise avoidable with a more efficient framework.

Beyond inefficiency and slow speeds, conventional digital communication systems are often inflexible. To elaborate, conventional systems often store large numbers of platform-specific video calling applications for each different operating system, device type, and/or geographic area. In many cases, these platform-specific video calling applications are independent of one another and are separately managed and stored at the server. Consequently, many existing systems are rigidly fixed to generating and updating new video calling applications for each different platform or use case. Indeed, due to the nature of their video calling library architecture, these existing systems cannot adapt the functionality of video calling applications in a flexible manner across different platforms.

Thus, there are disadvantages with regard to conventional digital communication systems.

### SUMMARY

One or more embodiments described herein provide benefits and solve one or more of the foregoing or other problems in the art with systems, methods, and non-transitory computer readable media that can efficiently, quickly, and flexibly generate, update, and otherwise manage video calling applications utilizing an adaptive video calling library architecture. For example, as part of the architecture, the disclosed systems can store a set of core video calling functions in a function repository. In some cases, the disclosed systems can encode the core video calling functions in a format accessible across all platforms (e.g., as binary video calling functions) and can include only video calling functions that are universally used across all platforms and use cases as core video calling functions. In addition, the disclosed systems can further store and manage additional video calling functions that are flexibly addable to the core video calling functions as part of an overall video calling application. In response to a request to generate or update a video calling application (e.g., from a developer device) that includes specific functions (e.g., for a particular operating system, product, device type, or geographic region), the disclosed systems can combine the core video calling functions with additional video calling functions to match the request.

To illustrate, the disclosed systems can store, at a video calling server, a video calling application library comprising a set of encoded core video calling functions compatible across a plurality of video calling applications and video calling platforms, receive a request for generating a video calling application comprising the set of encoded core video calling functions and one or more additional video calling functions, generate the video calling application to include the set of encoded core video calling functions and the one or more additional video calling functions, and provide the video calling application to a client device in response to a download request.

Moreover, in one or more embodiments, the disclosed systems encode video calling functions that enable video calls which facilitate augmented reality (AR) background environments. In particular, the disclosed systems can establish a video call between client devices. Additionally, the disclosed systems can enable a client device to segment one or more participant users captured via a video on the client device from a captured background from the video. Furthermore, the disclosed systems can enable the client device to render, in place of the segmented background, AR background environments (or spaces) to place captured videos of the one or more participant users (as a segmented user portion(s)) within an AR background space. Moreover, the disclosed systems can also enable the client device to track movement of a participant and/or movement of the client device to update a rendering of an AR background environment based on the tracked movement. For example, the disclosed systems can enable the client device to render the AR background environment to display different viewpoints (or portions) of an AR background environment when movement of the client device and/or participant is detected by the client device to simulate an AR background environment that is viewable from 360-degree (or other various) viewing angles.

To illustrate, the disclosed systems can conduct, by a client device, a video call with a participant device by receiving video data through a video data channel established for the video call from the participant device, render, within a digital video call interface, a portion of a video captured by the client device within a three-dimensional (3D) augmented reality (AR) space, and transmit, from the client device, a video stream depicting the 3D AR space to the participant device during the video call.

Additionally, in one or more implementations, the disclosed systems can implement (or facilitate) functions that enable secure payment transactions through a secure voice channel between a user operating within an extended-reality environment (e.g., via an extended-reality device) and another user within a real-world environment (e.g., via a client device). In particular, the disclosed system can receive (or detect) a user interaction with an object within an extended-reality environment presented by an extended-reality device for a user. Furthermore, the disclosed system can identify an additional user (e.g., merchant user, business entity, or another user) associated with the object and initiate a communication channel between the extended-reality device of the user and the additional user (e.g., a voice-based communication channel, a video-audio-based communication channel). In addition, the disclosed systems can securely facilitate the transmission of payment transaction data from the extended-reality device to the additional user via the communication channel. In some implementations, the disclosed systems facilitate payment transactions over a voice call from the extended-reality device of the user operating in the extended-reality environment to the merchant client device corresponding to the additional user (or vice versa).

To illustrate, the disclosed systems can detect a user interaction with an object within an extended-reality environment from a first client device, establish a voice channel between the first client device and a second client device associated with the object from the extended-reality environment while the first client device presents the extended-reality environment, and facilitate a payment transaction between the first client device and the second client device through the voice channel for a product represented by the object within the extended-reality environment while the first client device presents the extended-reality environment.

In addition, in one or more implementations, the disclosed systems can implement (or facilitate) functions that render animated avatars utilizing visemes identified from audio data captured by a client device during a video call. In particular, the disclosed systems can establish a video call between client devices. During the video call, upon identifying that a video capture is muted (e.g., displaying no video), the disclosed systems can utilize audio data of a user to identify speech visemes for the user. Moreover, the disclosed systems can utilize the speech visemes to display an animated avatar for the user (during the video call) in which the animations match speech behavior indicated by the speech visemes.

To illustrate, the disclosed systems can establish, by at least one processor, a video call with a recipient client device, identify, by the at least one processor, a viseme from audio data captured during the video call, and generate, by the at least one processor, an animated avatar for the video call utilizing the identified viseme.

Additional features and advantages of the present application will be set forth in the description which follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates a schematic diagram of an example environment for implementing a video calling library system in accordance with one or more implementations.

FIG. 2 illustrates an overview of generating or updating a video calling application and providing the updated video calling application to a client device in accordance with one or more implementations.

FIG. 3 illustrates an example video calling library architecture in accordance with one or more implementations.

FIG. 4 illustrates generating and providing different video calling applications to different client devices in accordance with one or more implementations.

FIG. 5 illustrates an AR video call system establishing a video call between participant client devices with an AR background environment (within video call interfaces) in accordance with one or more implementations.

FIG. 6 illustrates a flow diagram of an AR video call system establishing a video call and a client device rendering an AR background environment during the video call in accordance with one or more implementations.

FIG. 7 illustrates an AR video call system enabling a client device to segment a background and a foreground depicting a participant from a video to render a foreground segmented portion within an AR background environment in accordance with one or more implementations.

FIGS. 8A and 8B illustrate a client device initializing an AR background environment through one or more selectable options in accordance with one or more implementations.

FIG. 9 illustrates a client device utilizing tracked movements to update a rendering of a 360 AR background environment during a video call in accordance with one or more implementations.

FIG. 10 illustrates a client device initiating a video call with a persistent AR background environment in accordance with one or more implementations.

FIG. 11 illustrates an AR video call system enabling a client device to layer an AR effect on an AR background environment video call by imposing an avatar of a participant within a rendered AR background environment in accordance with one or more implementations.

FIG. 12 illustrates a client device receiving a user interaction to modify an AR background environment in accordance with one or more implementations.

FIG. 13 illustrates a schematic diagram of an exemplary system environment in which an extended-reality transaction system can be implemented in accordance with one or more implementations.

FIG. 14 illustrates an extended-reality transaction system facilitating a payment transaction between an extended-reality device with a client device in accordance with one or more implementations.

FIG. 15 illustrates an extended-reality transaction system enabling a transmission of payment information over a secured voice channel between a user interacting within an extended-reality environment and a user operating within a real-world environment in accordance with one or more implementations.

FIG. 16 illustrates a schematic diagram of an exemplary system environment in which an audio-based avatar animation system can be implemented in accordance with one or more implementations.

FIG. 17 illustrates an audio-based avatar animation system determining visemes from audio data during a video call and utilizing determined visemes to render an animated avatar in accordance with one or more implementations.

FIG. 18 illustrates a flowchart of a series of acts for animating an avatar (during a video or audio call) using audio data in accordance with one or more implementations.

FIG. 19 illustrates a flowchart of a series of acts for enabling secure voice-based payments between a device facilitating a user interaction within an extended-reality device and another device facilitating a user interaction within a real-world environment in accordance with one or more implementations.

FIG. 20 illustrates a flowchart of a series of acts for enabling video calls which facilitate augmented reality (AR) background environments in accordance with one or more implementations.

FIG. 21 illustrates a block diagram of an example computing device in accordance with one or more implementations.

FIG. 22 illustrates an example environment of a networking system in accordance with one or more implementations.

FIG. 23 illustrates an example social graph in accordance with one or more implementations.

### DETAILED DESCRIPTION

One or more embodiments described herein provide benefits and solve one or more of the foregoing or other problems in the art with a video calling library system that can generate, update, and otherwise manage video calling applications utilizing an adaptive video calling library architecture. In particular, the video calling library system can store and manage video calling functions in a video calling library for universal relevance and incorporation into a variety of video calling applications across different platforms, operating systems, products, device types, and/or geographic regions. For example, the video calling library system generates and manages a set of core video calling functions that are generic enough to support (e.g., that are used or required by) a number of video calling applications, including lightweight applications for certain (e.g., less capable) client devices and/or bad network conditions as well as high-function video calling applications with more video calling functions for other (e.g., more capable) client devices, and/or good network conditions.

In prior systems, the goal was to build the most feature-rich experience possible for devices. However, with added video calling, group calling, video chat heads, interactive AR effects, and extended-reality environment capabilities, and with millions of people using video calling (or other augmented-reality and/or virtual-reality-based communications) every month, a full-featured library that looks simple on the surface had become far more complex behind the scenes. In some cases, libraries end up storing a large amount of application-specific code, which makes it hard to support video calling in other apps. Prior systems sometimes included separate signaling protocols for group calling and peer-to-peer calling, which required writing features twice and creating a large divide in the codebase. Updates to WebRTC to keep current with the latest improvements from open source can also by computationally expensive and time-consuming in existing systems.

As described herein, the video calling library system can provide several advantages or improvements over conventional digital communication systems. For example, the video calling library system can improve efficiency over conventional digital communication systems. In particular, the video calling library system can improve efficiency by requiring fewer computing resources in storing managing, and updating video calling applications. While many conventional systems generate and store many video calling applications that are entirely separate from one another (and that can grow to excessive sizes), the video calling library system stores and manages a set of small, efficient core video calling functions that are universally incorporated into many video calling applications. The video calling function can augment or modify a video calling application by removing, adding, or changing additional video calling functions that are separate from the core video calling functions, leaving the core video calling functions unchanged in the process. The video calling library system thus requires less storage than conventional systems and further accommodates size-constrained platforms much more readily than prior systems. In some embodiments, the video calling library system reduces the size of the binary size of the core video calling functions by approximately 20% compared to some existing systems (e.g., from 9 MB to 7 MB) and even more compared to others (e.g., from 20 MB to 7 MB for some), making video calling applications easier (e.g., less computationally expensive) to update, manage, and test.

In addition to improving efficiency, the video calling library system can also improve speed over conventional digital communication systems. To elaborate, the video calling library system can achieve faster loads, updates, and initializations (e.g., startups) compared to prior systems (across various client devices and/or network conditions). For example, because video calling applications in many conventional systems are excessively large, it takes longer for client devices to download the applications, longer for servers to update the applications, and longer for client devices to initialize or start the applications for use. By contrast, the video calling library system generates and utilizes a video calling library architecture that facilitates much faster video calling applications that are faster to update, load, and start.

Beyond improving efficiency and speed, the video calling library system can further improve flexibility over conventional systems. In particular, the video calling library system can flexibly adapt video calling applications to different scenarios or platforms. As opposed to some existing systems that require managing, storing, and providing entirely separate (e.g., with little or no shared code) video calling applications for different platforms, the video calling library system utilizes an adaptive video calling library architecture that facilitates flexible modifications to a set of core video calling functions to add functionality for different video calling applications. In some cases, the video calling library system adds functions in a plug-and-play manner, where video calling functions beyond the set of core functions are stored on compartmentalized or containerized blocks addable to (and removable from) a video calling application in a piecewise fashion. This improved flexibility lays the foundation for remote presence and interoperability across apps and platforms.

To accomplish the aforementioned advantages, the video calling library system implements a video calling library architecture with several major changes. Signaling: The video calling library system utilizes a state machine architecture (e.g., the video calling library architecture) for a signaling stack that can unify protocol semantics for both peer-to-peer and group calling. The video calling library system abstracts out any protocol-specific details away from the rest of the library and provides a signaling component with the sole responsibility of negotiating shared state between call participants. By cutting duplicate code, the video calling library system is able to write features once, allow easy protocol changes, as well as provide a unified user experience for peer-to-peer and group calling.

Media: The video calling library system utilizes a state machine architecture (e.g., the video calling library architecture) and applies it to a media stack. In doing so, the video calling library system also captures the semantics of open source (e.g., WebRTC) APIs. In parallel, the video calling library system also replaces a previous version (e.g., a forked version of WebRTC), keeping any product-specific optimizations. This modular nature gives the video calling library system the ability to change the WebRTC version underneath the state machine as long as the semantics of the APIs themselves do not change significantly (e.g., for regular pulls from the open source codebase). This enables the video calling library system to easily update to the latest features without any downtime or delays.

SDK: In order to have feature-specific states, the video calling library system leverages a FLUX architecture to manage data and provide an API for calling products (e.g., products that work similarly to REACT JS-based applications). Each API call results in specific actions being routed through a central dispatcher. These actions are then handled by specific reducer classes and emit out model objects based on the type of action. These model objects are sent to bridges that contain all the feature-specific business logic and result in subsequent actions to change the model. Finally, all model updates are sent to the UI, where they are converted into platform-specific view objects for rendering. This allows the video calling library system to clearly define a feature comprising a reducer, bridge, actions, and models, which in turn allows the video calling library system to make features configurable at runtime for different apps.

OS: To make the video calling library system generic and scalable across various products, the video calling library system abstracts away any functionality that directly depends on the OS. Having platform-specific code for Android, iOS, etc. is necessary for certain functions like creating HW encoders, decoders, threading abstractions, etc., but the video calling library system uses generic interfaces for these so that platforms such as MacOS and Windows can easily plug in by providing different implementations through proxy objects. The video calling library system also heavily uses a library in BUCK to configure platform-specific libraries in an easy way for compiler flags, linker arguments, etc.

As mentioned above, the video calling library system 102 can facilitate various video calling functions. In some cases, the video calling library system 102 can facilitate an AR video calling system that can enable a client device to render an augmented reality background environment (e.g., a three-dimensional AR space) during a video call. In particular, the AR video calling system can establish a video call between client devices. Moreover, the AR video call system can enable a client device to segment one or more participants captured via videos on the client device from a captured background. Additionally, the AR video call system can enable the client device to render, in place of the segmented background, an AR background environment to place the captured video of the one or more participants within an AR background space to create the perception that the participant(s) of the video call are present in a realistic location (or setting). For example, the AR video call system can enable the client device to render the AR background environments as a 360 AR environment that renders a three-dimensional (3D) AR space and/or AR effects as a background for a video call participant that is viewable from multiple viewing angles (e.g., 360 degrees, 270 degrees) utilizing movement of a participant and/or movement of the client device.

To illustrate, the AR video call system can enable a client device to segment a background from a participant within a captured video and render an AR background environment (e.g., 3D AR space) in place of the segmented background. In one or more embodiments, the AR video call system enables the client device to utilize movement of the client device and/or movement of the participant to render the AR background environment from various viewing angles (e.g., as a 360-degree background space). In addition, the AR video call system can enable the client device to provide a video stream of the participant with the AR background environment to other participant client devices during the video call. In certain instances, the AR video call system enables the client devices of the video call to each render the same (or different) AR background environments and provide video streams portraying the participant with the AR background environments during the video call.

In one or more embodiments, the AR video call system enables a client device to provide, for display via a menu option interface during a video call, various selectable AR background environments. Upon receiving a selection of a selectable AR background environment, the AR video call system can enable the client device to render the AR background environment in place of a segmented background of a video captured on the client device during the video call. Indeed, the AR video call system can provide various selectable AR background environments within a menu option interface, during a video call, to represent various themes or locations within AR spaces.

In some instances, the AR video call system maintains a persistent AR background environment for a client device of a participant between multiple video calls. In particular, the AR video call system can save (or remember) an AR background environment selection and/or modifications to an AR background environment for a client device. Then, upon receiving or initiating a video call via the client device, the AR video call system can initiate the video call with the saved AR background environment. In addition, the AR video call system can also enable the video call between the participant devices to include various AR effects (or objects) and/or various other modifications in the AR background environment (from historical video calls of the participant associated with the client device).

Moreover, the AR video call system can enable a client device to utilize layering to render an AR background environment and an avatar for a participant captured on a video call. For example, the AR video call system can enable a client device to capture a video of a participant and render the participant as an avatar within a video call. In addition, the AR video call system can also enable the client device to render the AR background environment (with varying views based on movement) as a background for the rendered avatar within the video call.

Indeed, the AR video call system provides many technical advantages and benefits over conventional systems. For instance, the AR video call system can establish and enable dynamic and flexible video calls between a plurality of participant devices that include interactive AR content. For example, unlike many conventional video call systems that are limited to rendering AR effects selected by a participant device for a captured video and streaming the captured video portraying the non-interactive (overlayed) AR effect to other client devices, the AR video call system enables participant devices to initiate interactive AR effects (and/or other AR elements) that create an immersive extended-reality environment during a video call.

Moreover, the individual participant devices can accurately render AR background environments using a fully captured video to realistically place a participant within the AR space while efficiently displaying the AR space to other participant devices during the video call. In particular, the AR video call system can accurately segment participants captured in videos and insert the segmented videos within a rendered AR space. Indeed, through segmentation, the AR video call system can realistically insert participants of a video call within AR spaces that change according to the movement of a participant client device during the video call.

As illustrated by the foregoing discussion, the present disclosure utilizes a variety of terms to describe features and benefits of the AR video call system facilitating a client device to render an AR background environment during a video call. Additional detail is now provided regarding the meaning of these terms. For instance, as used herein, the term “video call” refers to an electronic communication in which video data is transmitted between a plurality of computing devices. In particular, in one or more embodiments, a video call includes an electronic communication between computing devices that transmits and presents videos (and audio) captured on the computing devices.

As used herein, the term “channel” refers to a medium or stream utilized to transfer data (e.g., data packets) between client devices and/or a network. In some cases, the term “video data channel” can refer to a medium or stream utilized to transfer video data between client devices and/or a network. Indeed, the video data channel can enable the transfer of a continuous stream of video data between client devices to display a video (e.g., a collection of moving image frames). In some cases, a video data channel can also include audio data for the captured video. In addition, the term “audio data channel” can refer to a medium or stream utilized to transfer audio data between client devices and/or a network that enables the transfer of a continuous stream of audio between client devices to play audio content (e.g., a captured recording from a microphone of a client device).

Additionally, as used herein, the term “augmented reality data channel” refers to a medium or stream utilized to transfer AR data between client devices and/or a network (for a video call). For example, the term “augmented reality data channel” can enable the transfer of a continuous stream (and/or a situational transmission and/or request) of AR data between client devices to communicate AR content and interactions with AR content between the client devices (e.g., AR elements, AR environment scenes, interactions with AR, AR object vectors). In some cases, the AR video call system utilizes data-interchange formats such as JavaScript Object Notation (JSON), real time protocol (RTP), and/or extensible markup language (XML) to write, transmit, receive, and/or read AR data from the AR data channel.

As used herein, the term “augmented reality element” (sometimes referred to as an “augmented reality object”) refers to visual content (two dimensional and/or three dimensional) that is displayed (or imposed) by a computing device (e.g., a smartphone or head mounted display) on a video (e.g., a live video feed) of the real world (e.g., a video capturing real world environments and/or users on a video call). In particular, the term “augmented reality element” can include a graphical object, digital image, digital video, text, and/or graphical user interface displayed on (or within) a computing device that is also rendering a video or other digital media. For example, an augmented reality element can include a graphical object (e.g., a three dimensional and/or two-dimensional object) that is interactive, manipulatable, and/or configured to realistically interact (e.g., based on user interactions, movements, lighting, shadows) with an environment (or person) captured in a video of a computing device. Indeed, in one or more embodiments, an AR element can modify a foreground and/or background of a video and/or modify a filter of a video.

Additionally, as used herein, the term “augmented reality environment scene” refers to one or more augmented reality elements that are interactive, manipulatable, and/or configured to realistically interact with each other and/or user interactions detected on a computing device. In some embodiments, an augmented reality environment scene includes one or more augmented reality elements that modify and/or portray a graphical environment in place of a real-world environment captured in a video of a computing device. As an example, the AR video call system can render an augmented reality environment scene to portray one or more participants of a video call to be within a graphical environment (e.g., in space, underwater, at a campfire, in a forest, at a beach) within a captured video of a computing device. In some cases, the AR video call system further enables augmented reality elements within the augmented reality environment scene to be interactive, manipulatable, and/or configured to realistically interact to user interactions detected on a plurality of participant devices.

In addition, an augmented reality environment scene can include a 360 augmented reality background environment (or augmented reality background environment). As used herein, the term “augmented reality environment scene” (sometimes referred to as a three-dimensional augmented reality space with varying viewpoint degrees or 360 augmented reality background environment) refers to one or more augmented reality elements that portray a graphical environment in place of a background in a real-world environment captured in a video of a computing device as a 360-degree space (or various other multi-view spaces). For example, the AR video call system can cause a client device to render a 360 augmented reality background environment within a video that represents a 360-degree space (e.g., with an on-screen rendered background and off-screen portions of the background) as a background for a participant.

Additionally, the AR video call system can cause a client device to render different portions of the 360-degree space of the 360 augmented reality background environment when movement is detected from a participant client device (or a participant captured in a video on the participant client device). As an example, a 360 AR background environment can include a 360 AR space depicting spaces, such as a virtual office space, a virtual beach house, a virtual city, a virtual space station, a virtual museum, and/or a virtual aquarium. In one or more embodiments, the 360 AR background environment (or augmented reality background space) can include both two-dimensional and/or three-dimensional environments.

Furthermore, the term “segmentation” refers to a computer-based process to identify and partition particular regions (or segments) within an image (or video). For example, in one or more embodiments, the AR video call system can enable a client device to segment a background of a video from a foreground of the video (e.g., a foreground that portrays a salient subject, such as a person). In some cases, the AR video call system can enable a client device to segment a participant user depicted within a video from the background of the video to generate a video layer that depicts the participant user with a transparent background. In one or more instances, the AR video call system can enable a client device to utilize various image (or video) processing tools to perform segmentation, such as, but not limited to, machine learning-based segmentation models or classifiers (e.g., convolutional neural networks, generative adversarial neural networks).

Moreover, as used herein, the term “augmented reality effect” refers to one or more augmented reality elements that present (or display) an interactive, manipulatable, and/or spatially aware graphical animation. In particular, the term “augmented reality effect” can include a graphical animation that realistically interacts with a person (or user) captured within a video such that the graphical animation appears to realistically exist in the environment of the person within the captured video. As an example, an augmented reality effect can include graphical confetti, graphical hats worn by video call participants, graphical characters, objects (e.g., vehicles, plants, buildings), and/or modifications to persons captured within the video call (e.g., wearing a mask, change to appearance of a participating user on a video call, change to clothing, an addition of graphical accessories, a face swap).

As further used herein, the term “user interaction” refers to an action or input detected by a participant device via a camera, touch screen, and/or computer peripheral (e.g., mouse, keyboard, controller). In some cases, the term “user interaction” includes a user input that interacts with a displayed AR element. Furthermore, the term “user interaction” can include a movement interaction detected by a camera of a client device. For example, a movement interaction can include a physical movement of a user (e.g., a face movement, an arm movement, a leg movement) detected by a camera that intersects (or relates to) a position of an AR element. As an example, a movement interaction can include, but is not limited to, detecting, using a client device camera, a user tapping an AR element, swatting an AR element, and/or kicking an AR element. Additionally, a movement interaction can include, but is not limited to, detecting, using the client device camera, eyes of a user opening, a user taking an action to blow air at an AR-based object (e.g., blowing out an AR-based candle, blowing away AR-based leaves) and/or a user taking an action to bite an AR-based object (e.g., eating AR-based food, moving an AR-based object using head movements).

As further used herein, the term “avatar” (sometimes referred to as a “digital avatar”) refers to a visually human-like (e.g., anthropomorphic), three-dimensional representation (or persona) of a user within an AR environment. As an example, an avatar can include a three-dimensional representation of a user that provides a realistic (e.g., accurate, life-like, and/or photorealistic) portrayal of the user within the AR environment. Additionally, an avatar can also include a three-dimensional representation of a user that provides a simplified (e.g., animated, caricature-like, cartoon-like) portrayal of the user within the AR environment.

As also used herein, the term “video processing data” refers to data representing properties of a video. In particular, the term “video processing data” can refer to data representing properties or characteristics of one or more objects depicted within a video. For example, video processing data can include face tracking (or face recognition) data that indicates features and/or attributes of one or more faces depicted within a video (e.g., vectors and/or points that represent a structure of a depicted face, bounding box data to localize a depicted face, pixel coordinates of a depicted face). In addition, video processing data can include segmentation data that indicates background pixels and/or foreground pixels (e.g., saliency) and/or mask data that utilize binary (or intensity values) per pixel to represent various layers of video frames (e.g., to distinguish or focus on objects depicted in a frame, such as hair, persons, faces, and/or eyes).

In some cases, the AR video call system can generate (or cause a client device to generate) combined video data from video data and video processing data. For example, in some cases, combined video data can include a split frame that include a video frame in a first portion of the frame (e.g., a lower resolution frame of from an original video frame) and video processing data (e.g., a segmentation mask, face tracking pixels) on the second portion of the frame. In one or more implementations, combined video data can include alternating frames in which a first frame includes a video frame and a second, subsequent video frame includes video processing data in a video stream.

In addition, video processing data can include alpha channel data that indicates degrees of transparency for various color channels represented within video frames. Furthermore, video processing data can include participant metadata that can classify individual participants, label individual participants (e.g., using participant identifiers), participant names, statuses of participants, and/or number of participants. The video processing data can also include metadata for the video stream (e.g., a video resolution, a video format, camera focal length, camera aperture size, camera sensor size). Indeed, the AR video call system can enable client devices to transmit video processing data that indicates various aspects and/or characteristics of a video or objects depicted within a video.

As used herein, the term “video texture” refers to a graphical surface that is applied to a computer graphics object to superimpose the computer graphics object with a video. In one or more embodiments, the term “video texture” refers to a computer graphics surface generated from a video that overlays or superimposes (i.e., maps) a video onto a graphics-based object (a three-dimensional object or scene, a still image, or a two-dimensional animation or scene). In some embodiments, the AR video call system enables a client device to render a video as a video texture within an AR effect such that the video texture depicts a captured video of a participant superimposed onto an AR effect within an AR scene (or environment).

In some cases, the video calling library system 102 can also facilitate (or implement) an extended-reality transaction system that can enable secure payment transactions through a secure voice channel between a user operating within an extended-reality environment (e.g., via an extended-reality device) and another user within a real-world environment (e.g., via a client device). In particular, the extended-reality transaction system can establish a secure voice channel between an extended-reality device, that is presenting (or displaying) an extended-reality environment to a first user, and another client device (e.g., associated with a second user that is related to the extended-reality environment scene). In one or more implementations, the extended-reality transaction system can enable the transmission (or communication) of payment information (for a payment transaction) through the secured voice channel between the first user operating within the extended-reality environment and a second user (e.g., located in a real-word setting but operating a client device or operating within the extended-reality environment via another extended-reality device). For instance, the extended-reality transaction system can facilitate payment transactions over a secured voice call from the extended-reality device of the user operating in the extended-reality environment to the merchant client device corresponding to the additional user.

In one or more embodiments, the extended-reality transaction system enables an extended-reality device to display an extended reality environment to a user. Indeed, the extended-reality transaction system can cause the extended-reality device to depict a virtual experience, a virtual place, or virtual people (e.g., other users operating in the extended-reality environment). In some cases, the extended-reality transaction system can enable an extended-reality device to display a virtual place or virtual person that has a real-world counterpart. For example, the extended-reality transaction system can cause the extended-reality device to present a virtual store front, a virtually represented user, and/or a virtual entertainment venue that the user operating the extended-reality device can interact with (e.g., to purchase one or more digital or real-world objects, to purchase digital content, to purchase entry to a virtual video stream or game, to trade with a virtually represented user).

Furthermore, in one or more embodiments, the extended-reality transaction system can detect a user interaction with an object or option within the extended-reality environment through an extended-reality device of a user. Upon detecting the interaction, the extended-reality transaction system can facilitate communication between the extended-reality device (e.g., of the user) and a client device of a user associated to the object or option within the extended-reality environment. Indeed, the client device of the user associated to the object can include a client device that enables a communication from a user situated in a real-world setting (e.g., a mobile phone of a store clerk, an electronic tablet of a store clerk) that is associated with or represented in the extended-reality environment (e.g., a virtual business front that corresponds to a real-world business location).

In addition, during the interaction between the extended-reality device of the user interacting within the extended-reality environment and the client device of the user associated to the object or option within the extended-reality environment, the extended-reality transaction system can enable a payment transaction between the devices. For instance, upon detecting a request to initiate a payment transaction from either of the devices, the extended-reality transaction system can establish a secure voice channel between the devices. Indeed, the extended-reality transaction system can enable the client devices (e.g., via the users) to exchange payment information over the secure voice channel.

In some cases, upon transmission of the payment information, the extended-reality transaction system can enable the client device (or the extended-reality device) to process the payment information while the user continues to operate within the extended-reality environment (via the extended-reality environment). Furthermore, upon completion of the payment transaction, the client device can also transmit payment confirmation to the extended-reality device or another client device (e.g., to display the payment confirmation). Additionally, upon completion of the payment transaction, the extended-reality transaction system can enable the client device to electronically deliver the purchased object (e.g., a digital file, a digital stream, a video game, a digital code, or digital ticket), initiate delivery of a physical product (e.g., a purchased product, a food delivery), initiate or continue a service (e.g., preparation of food at a restaurant, rent a car, renew or start a utility service, renew or start a streaming service, renew or start internet service), and/or contribute to a fund (e.g., a virtual fundraiser, a virtual bank).

The extended-reality transaction system provides many technical advantages and benefits over conventional systems. For example, many conventional systems capable of providing a multi-user extended-reality environment lack easy and efficient ways to facilitate payment interactions between users. In addition, oftentimes conventional extended-reality systems fail to easily and efficiently enable payment interactions between users operating within an extended-reality environment and other users operating client devices in real-world settings.

Unlike such conventional systems, the extended-reality transaction system can flexibly and efficiently facilitate and complete payment transactions from a user operating within an extended-reality environment to another user that is not operating within an extended-reality environment. Indeed, unlike many conventional systems that may require a user to switch between an extended-reality environment to a web browser or display a web browser to complete a transaction within the extended-reality environment, the extended-reality transaction system can enable a user to facilitate and complete a payment transaction without the additional steps of accessing a web browser. Rather, by establishing a secured voice channel between the users to communicate the payment information, the extended-reality transaction system enables a user to quickly and easily complete a payment transaction from an extended-reality device with another user (operating within or outside of the extended-reality environment) without additional navigation (e.g., by mimicking a transaction that occurs in a real-world setting). Moreover, in one or more embodiments, the extended-reality transaction system 1306 also enables a merchant device to complete payment transactions from users utilizing extended-reality devices to interact within an extended-reality environment without capabilities of interacting within the extended-reality environment (e.g., from a mobile phone, a laptop, or an electronic tablet).

In addition, the extended-reality transaction system also improves security while providing an easy-to-use payment transaction implementation across extended-reality settings and real-world settings. For example, by enabling communication through an encrypted voice channel, the extended-reality transaction system can facilitate communication (e.g., over voice) of sensitive payment information quickly and securely. Indeed, the extended-reality transaction system can encrypt the voice packets transmitted across the secured voice channel such that payment information of a user is not intercepted by a malicious third party when communicating from the extended-reality environment (on the extended-reality device) to a client device operated by a user in a real-world environment.

As used herein, the term “virtual reality environment” or “extended-reality environment” refers to a simulated environment in which users can fully or partially immerse themselves. For example, an extended-reality environment can comprise virtual reality, augmented reality, etc. An extended-reality environment can include objects and elements with which a user can interact (e.g., as an entertainment venue, as a social gathering space, as a gaming space). For example, an extended-reality environment can include a collection of graphical objects, elements, audio, and other users (e.g., represented as avatars or video representations) that creates a virtual world setting. In general, a user participates in a virtual environment using a client device, such as a dedicated extended-reality device.

As further used herein, the term “extended-reality device” refers to a computing device having extended reality capabilities and/or features. In particular, an extended-reality device can refer to a computing device that can display an extended reality graphical user interface. An extended-reality device can further display one or more visual elements within the extended reality graphical user interface and receive user input that targets those visual elements. For example, an extended-reality device can include, but is not limited to, a virtual reality device, an augmented reality device, or a mixed reality device. In particular, an extended-reality device can comprise a head-mounted display, a smartphone, or another computing device.

Additionally, as used herein, a “voice channel” (or sometimes referred to as a “audio data channel”) can refer to a medium or stream utilized to transfer audio data between client devices (e.g., mobile devices, extended-reality devices, electronic tablets, laptops) and/or a network that enables the transfer of a continuous stream of audio between client devices to play audio content (e.g., a captured recording from a microphone of a client device). For example, a voice channel can include a cellular phone call or a voice over IP (VoIP) call.

As further used herein, “payment transaction” (or sometimes referred to as a “transaction”) can refer to an interaction that causes a transfer or crediting of a transactional value (e.g., funds or money) from a user account (e.g., a bank or credit account corresponding to a user) to another user account (e.g., a bank or credit account corresponding to another user). For example, a payment transaction can include an electronic communication that indicates at least one of an account number, a transaction amount, and/or a transaction party. In some cases, a payment transaction includes, but is not limited to, online purchases, online payments, deposits, subscription payments, and/or point of sale transactions). Indeed, a payment transaction can include payment transaction information for a payment method, such as, but not limited to, a credit card, a bank account, and/or a digital wallet.

In one or more embodiments, the video calling library system 102 can also facilitate (or implement) an audio-based avatar animation system that renders an animated avatar depicting speech of a user utilizing audio data captured on a client device during a video call. For instance, during a video call, the audio-based avatar animation system can determine that a video of a user corresponding to a participant device is not available (e.g., video is turned off, camera is unavailable, or video connection is unavailable or inadequate). Subsequently, instead of displaying a blank screen for the user's portion of the video cell during a video call, the audio-based avatar animation system can utilize audio data captured on the participant device to determine speech visemes of the user. Moreover, the audio-based avatar animation system can utilize the determined speech visemes to animate an avatar corresponding to the user for display during the video call (e.g., to render an avatar that puppets the speech provided by a user on the participant device).

The audio-based avatar animation system provides many technical advantages and benefits over conventional systems. For example, the audio-based avatar animation system can mimic actions of a user participating in a video call to animate an avatar to follow speech patterns of the user without utilizing video data. Indeed, the audio-based avatar animation system can flexibly mimic speech actions of a user participating on a video call in an animated avatar by identifying speech visemes from audio data captured within a client device. Accordingly, the audio-based avatar animation system can animate an avatar to represent a user in a video call even when a camera is disabled or unavailable during a video call.

In addition, the audio-based avatar animation system also improves computational efficiency of animating an avatar according to a user participating on a video call. In particular, the audio-based avatar animation system reduces the utilization of input data (e.g., video data) while accurately animating avatars to mimic a user speaking during a video call. Likewise, the audio-based avatar animation system also improves computational efficiency by animating avatars to mimic a user speaking during a video call without activating hardware, such as a camera during a video call.

As used herein, the term “viseme” refers to a decomposable unit of representation for visual speech. In one or more embodiments, the term “viseme” refers to a decomposable unit that represents a mouth shape or a mouth movement for one or more audible phonemes (that represent a group of sounds). For example, a viseme includes a visual movement (e.g., mouth shape or movement) that represents one or more phonemes. In some cases, a viseme represents a distinct mouth movement that maps to one or more particular phonemes (e.g., a first viseme, FF, that maps to the phonemes f,v and a second viseme, TH, that maps to the phoneme th). In some cases, a group or sequence of visemes can represent mouth shapes or movements made to produce an audible word or phrase.

As used herein, the term “audio” (or sometimes referred to as “audio data”) refers to information that represents or depicts sound effects or sound waves. For example, audio data can include captured recordings from a microphone of a client device of sounds created by a user operating the client device (e.g., via speech, movement, or actions).

### Generating and Modifying Video Calling Applications Utilizing an Adaptive Video Calling Library Architecture

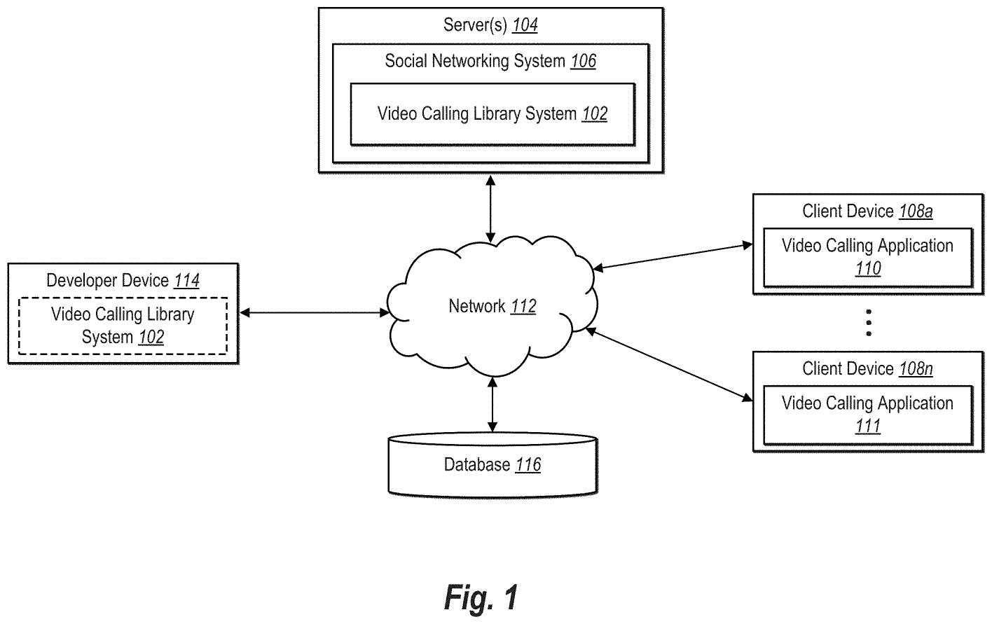

Additional detail regarding the video calling library system will now be provided with reference to the figures. For example, FIG. 1 illustrates a schematic diagram of an example environment for implementing a video calling library system 102 in accordance with one or more embodiments. An overview of the video calling library system 102 is described in relation to FIG. 1. Thereafter, a more detailed description of the components and processes of the video calling library system 102 is provided in relation to the subsequent figures.

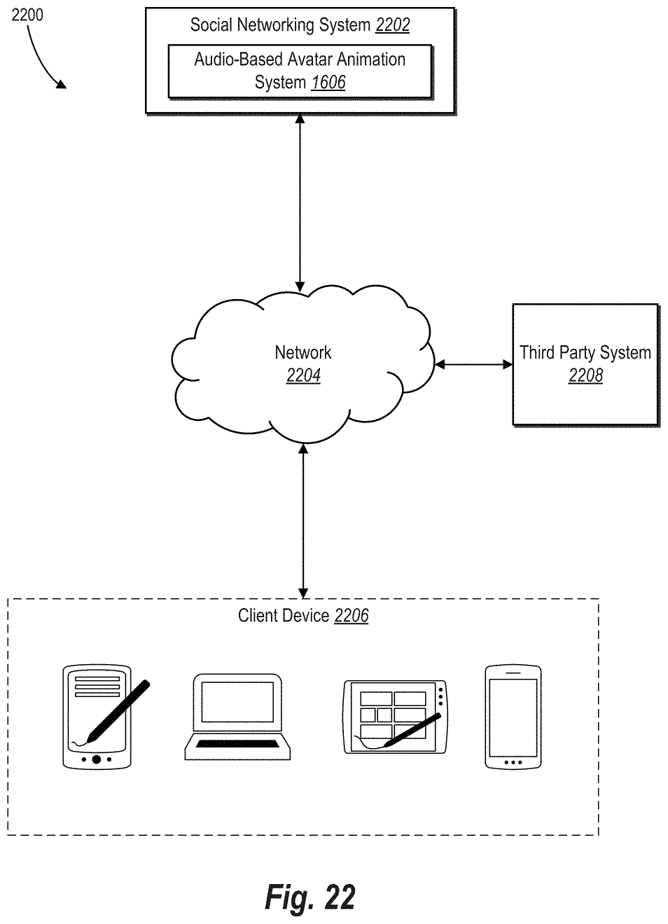

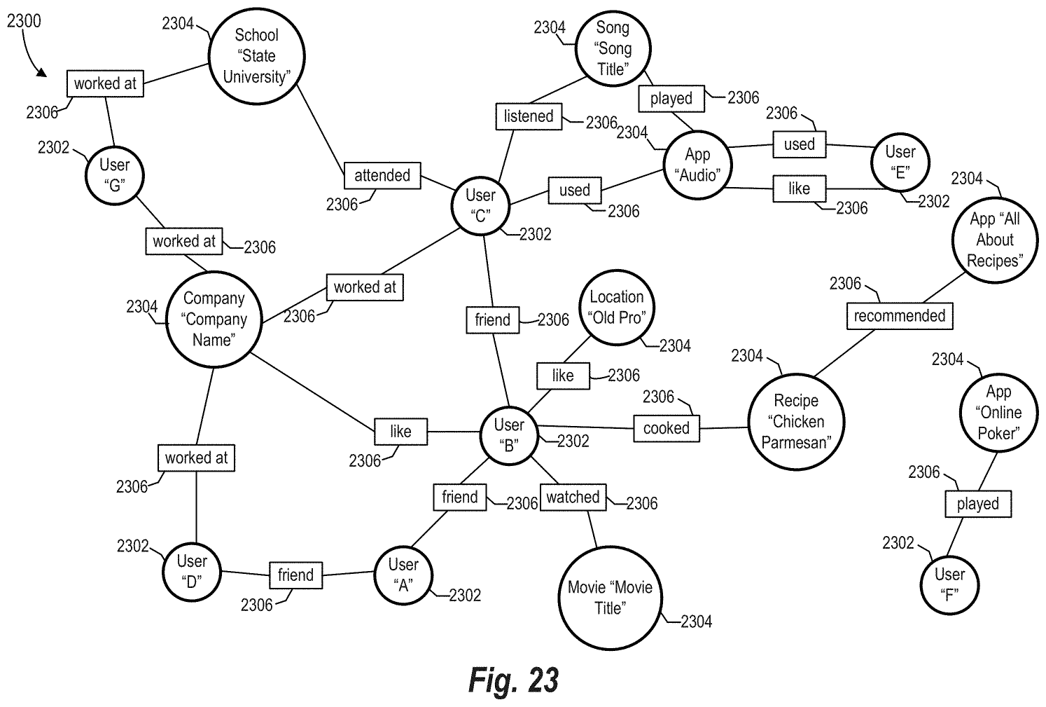

As shown in FIG. 1, the environment includes server(s) 104, client devices 108a-108n, a developer device 114, a database 116, and a network 112. Each of the components of the environment can communicate via the network 112, and the network 112 may be any suitable network over which computing devices can communicate. Example networks are discussed in more detail below in relation to FIGS. 22 and 23.

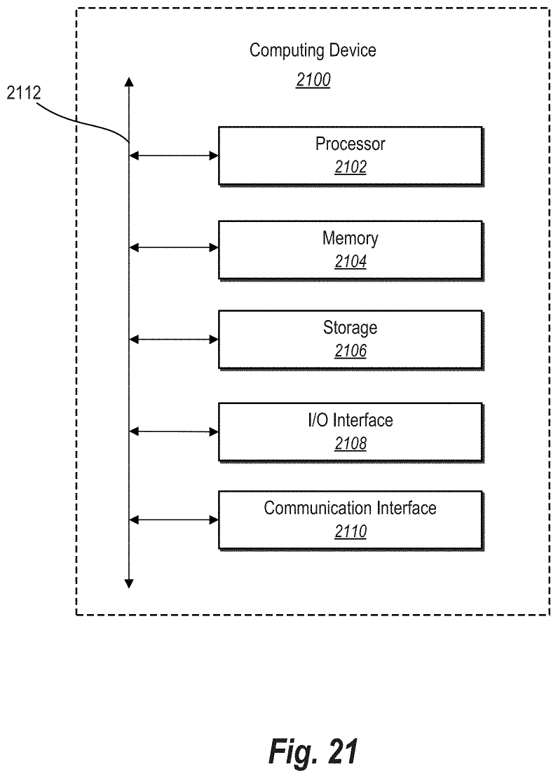

As mentioned, the environment includes client devices 108a-108n. The client devices 108a-108n can be one of a variety of computing devices, including a smartphone, a tablet, a smart television, a desktop computer, a laptop computer, a virtual reality device, an augmented reality device, or some other computing device as described in relation to FIGS. 21 and 22. The client devices 108a-108n can receive user input from users in the form of user actions such as touch gestures, clicks, etc., in relation to user interface elements displayed as part of the video calling application 110 or the video calling application 111. In some embodiments, the client devices 108a-108n are associated with respective users of the social networking system 106, where the users have social media accounts or user accounts registered with the social networking system 106.

The client devices 108a-108n can also provide information pertaining to user input to the server(s) 104. Thus, the video calling library system 102 on the server(s) 104 can receive user input information from the client devices 108a-108n to indicate actions within the video calling application 110 for initiating a video call, participating in a video call, providing electronic communications between the client devices 108a-108n, and initiating a video calling. In some embodiments, the video calling library system 102 provides different video calling applications (e.g., with different video calling functions) to different client devices 108a-108n. As shown, the video calling library system 102 provides a video calling application 110 to the client device 108a and provides a video calling application 111 to the client device 108b, where the video calling application 110 and the video calling application 111 have different video calling functions (but share the same set of core video calling functions).

Indeed, the client devices 108a-108n include a video calling application 110 and a video calling application 111. In particular, the video calling application 110 and the video calling application 111 may be a web application, a native application installed on the client devices 108a-108n (e.g., a mobile application, a desktop application, a web-based browser application, etc.), or a cloud-based application where all or part of the functionality is performed by the server(s) 104. In some embodiments, the client device 108n includes a video calling application 111 that has different functionality than the video calling application 110 and can communicate with the video calling application 110 sending data back and forth. For example, the video calling application 110 can be a smaller, lighter application meant primarily for less resource-intensive functionality like messaging and video calling, while the video calling application 111 can be a larger application with more functionality including messaging, calling, social networking, payments, and other functions (or vice-versa). In some embodiments, the client device 108a includes the video calling application 110 but does not include the video calling application 111 (or vice-versa). In these or other embodiments, the client device 108n includes the video calling application 111. Thus, the video calling library system 102 can facilitate generating and providing different video calling applications to different client devices based on platform requirements, device requirements, product requirements, and/or geographic area requirements.

In some cases, the video calling application 110 can present or display information to a user such as a creator or an invitee, including a messaging interface, a video call interface, and/or a video calling interface. In some embodiments, the video calling application 111 provides additional functions not found in the video calling application 110 such as virtual reality functions, reaction functions, animation functions, or other non-core functions. In addition, the video calling application 110 facilitates the video calling for the client device 108a and the client device 108n to video call together.

As shown, the environment includes a developer device 114. In particular, the developer device 114 can be one of a variety of computing devices, including a smartphone, a tablet, a smart television, a desktop computer, a laptop computer, a virtual reality device, an augmented reality device, or some other computing device as described in relation to FIGS. 21 and 22. In some embodiments, the developer device 114 receives user interaction from a developer to generate, update, or modify a video calling application. For example, the developer device 114 adds, removes, or changes one or more video calling functions for a video calling application such as the video calling application 110 or the video calling application 111. In response, the video calling library system 102 updates respective video calling application by adding, removing, and/or modifying additional video calling functions while leaving the core video calling functions unchanged.

As illustrated in FIG. 1, the environment includes server(s) 104. The server(s) 104 may generate, store, process, receive, and transmit electronic data, such as creator profile information, invitee profile information, other social media account information, video calling information, user interaction information, affinity information, and user inputs. For example, the server(s) 104 can transmit data to the client devices 108a-108n to provide a video call interface and/or a video calling interface via the video calling application 110 or the video calling application 111. In some embodiments, the server(s) 104 comprises a digital content server. The server(s) 104 can also comprise an application server, a communication server, a web-hosting server, a social networking server, a video communication server, or a digital communication management server.

As shown in FIG. 1, the server(s) 104 can also include the video calling library system 102 (e.g., implemented as part of a social networking system 106). The social networking system 106 can communicate with the developer device 114 and/or the client devices 108a-108n. Although FIG. 1 depicts the video calling library system 102 located on the server(s) 104, in some embodiments, the video calling library system 102 may be implemented by (e.g., located entirely or in part) on one or more other components of the environment. For example, the video calling library system 102 may be implemented by the client devices 108a-108n, the server(s) 104 (externally from the social networking system 106), the developer device 114, and/or a third-party device.

In some embodiments, though not illustrated in FIG. 1, the environment may have a different arrangement of components and/or may have a different number or set of components altogether. For example, the developer device 114 and/or the creator client devices 108a-108n may communicate directly with the video calling library system 102, bypassing the network 112. Additionally, the video calling library system 102 can include a database 116 (e.g., a social media account database) housed on the server(s) 104 or elsewhere in the environment that stores a video calling library of video calling functions.

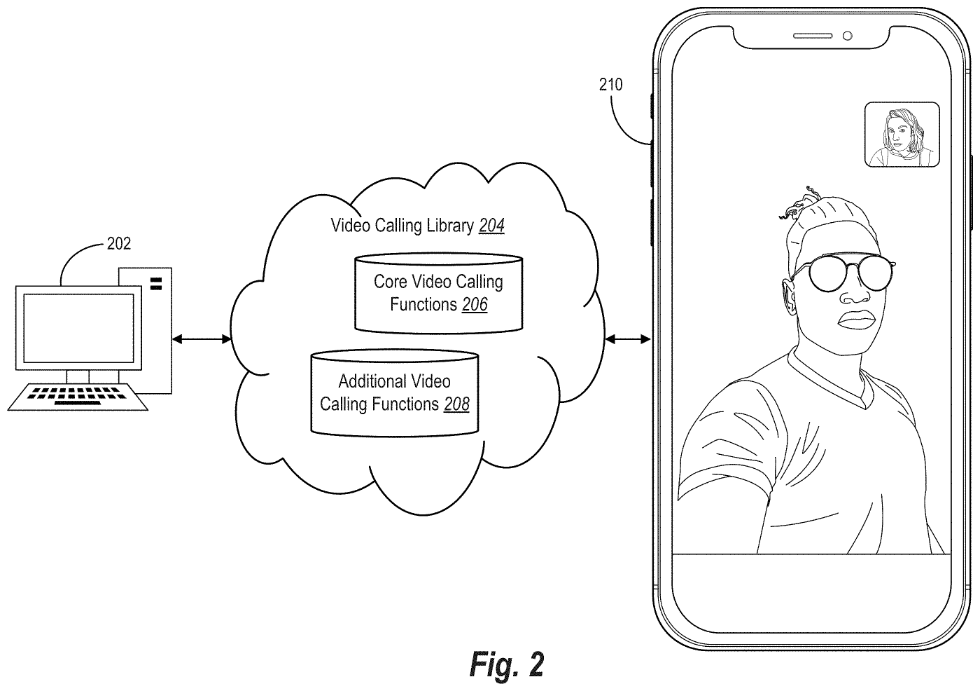

As mentioned, the video calling library system 102 can store and manage a video calling library of video calling functions in an adaptive architecture. In particular, the video calling library system 102 can manage a video calling library of core video calling functions (e.g., video calling functions used across all video calling applications, platforms, geographic areas, devices, and operating systems) and additional video calling functions (e.g., video calling functions that are not core or not universal across all use cases). FIG. 2 illustrates an overview of generating or updating a video calling application and providing the updated video calling application to a client device in accordance with one or more embodiments. Additional detail regarding the acts and processes described in FIG. 2 is provided thereafter with reference to subsequent figures.

As illustrated in FIG. 2, the video calling library system 102 receives a request to generate, update, or modify a video calling application. Specifically, the video calling library system 102 receives the request from a developer device 202 (e.g., the developer device 114). In some embodiments, the video calling library system 102 receives the request in the form of an edit or a modification to a video calling application. For example, the video calling library system 102 receives an indication to add, remove, or modify one or more video calling functions within the video calling application stored within a video calling library 204.

As further illustrated in FIG. 2, the video calling library system 102 utilizes the video calling library 204 to update or modify a video calling application. For example, the video calling library system 102 accesses a repository of core video calling functions 206 and a repository of additional video calling functions 208. In some cases, the video calling library system 102 generates or modifies a video calling application to always include the core video calling functions 206, regardless of the application, product, platform, device, or geographic region where the video calling application is to be implemented or run. Indeed, the core video calling functions 206 include only those lightweight video calling functions that are essential or core to video calling between devices, excluding non-essential functions.

As shown, the video calling library system 102 generates the video calling application to include the core video calling functions 206. In some cases, the video calling library system 102 further adds one or more of the additional video calling functions 208, depending on the circumstances. For example, depending on the capabilities (e.g., processing power, network access functions such as 4G or 5G, and memory) of the client device 210 (e.g., the client device 108a or 108n), the network quality of the client device 210, the geographic region associated with the client device 210, the operating system of the client device 210, and/or the actual product or application to be sent to the client device 210 (e.g., a lightweight application versus a full function application), the video calling library system 102 generates a video calling application to provide to the client device 210. As illustrated, the client device 210 displays a user interface of a video calling application including the core video calling functions 206 and one or more of the additional video calling functions 208.

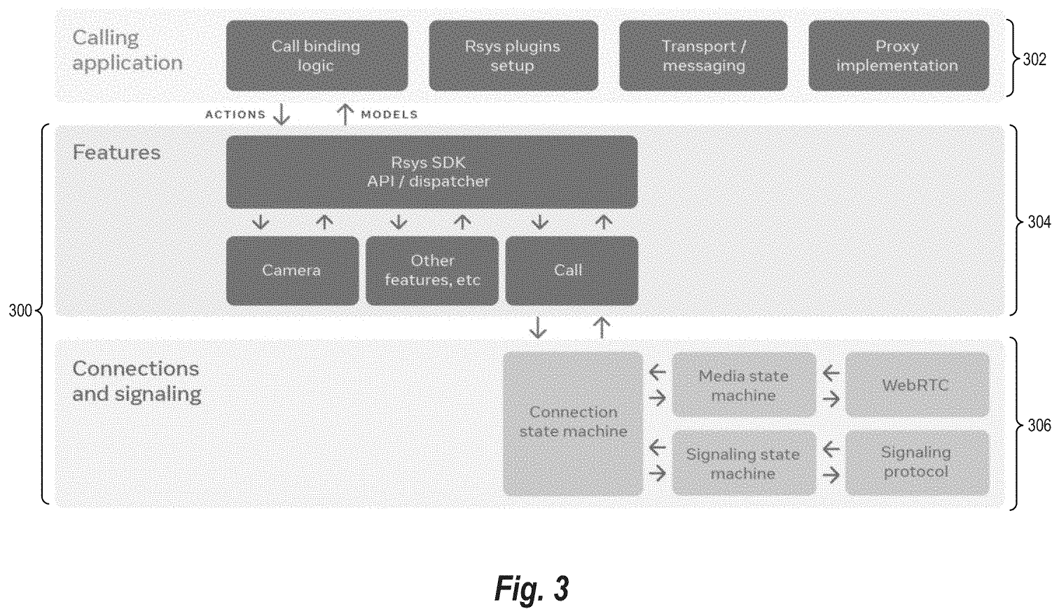

As mentioned above, in certain described embodiments, the video calling library system 102 utilizes a particular video calling library architecture to store and manage a library of video calling functions. In particular, the video calling library system 102 utilizes an adaptive video calling library architecture that flexibly adjusts video calling functions in a plug-and-play manner for different applications, devices, platforms, operating systems, or geographic regions. FIG. 3 illustrates an example video calling library architecture 300 in accordance with one or more embodiments.

In some embodiments, the video calling library architecture 300 is written in a particular programming language such as that supported by the open source WebRTC library. Indeed, the video calling library architecture 300 is a new video calling library compatible with all relevant products across various apps and services, including INSTAGRAM, MESSENGER, PORTAL, WORKPLACE CHAT, HORIZON WORLDS, AND OCULUS VR. To generate the video calling library architecture 300 in a format generic enough to support all these different use cases, in some cases, the video calling library system 102 utilizes the open source WebRTC library. Compared with the libraries of prior systems, the video calling library architecture 300 is capable of supporting multiple platforms, including Android, iOS, MacOS, Windows, and Linux.

In some embodiments, the video calling library architecture 300 introduces a plug-and-play framework using selects to compile features selectively into apps that need them, and introduces a generic framework for writing new features based on FLUX architecture. The video calling library architecture 300 also moves away from heavily templated generic libraries like FOLLY and towards more optimally sized libraries like BOOST.SML to realize size gains throughout all apps.

The video calling library architecture 300 is approximately 20 percent smaller than some prior libraries, which makes it easy to integrate into size-constrained platforms, such as Messenger Lite. In some cases, the video calling library architecture 300 has approximately 90 percent unit test coverage and a thorough integration testing framework that covers all our major calling scenarios. To accomplish this, the video calling library architecture 300 utilizes libraries and architecture for binary size wherever possible by separating the pieces needed for calling into isolated, standalone modules, and leveraging cross-platform solutions that are not reliant on the operating system and/or the environment.

As illustrated in FIG. 3, the video calling library architecture 300 includes a number of isolated modules or managers located within different layers of the video calling library architecture 300. For example, the layer 306 includes modules or managers relating to connections and signaling, while the layer 304 includes modules or managers relating to features of the video calling library architecture 300. As shown, the video calling application 302 (e.g., the video calling application 110 or the video calling application 111) includes various modules or managers for communicating with the video calling library architecture 300 to access video calling function or features for initiating and performing a video call. In some embodiments, the layer 306 includes a set of core video calling functions and excludes other non-core functions. In these or other embodiments, the layer 308 includes additional video calling functions not part of the core components required to run a bare-bones video calling application (or to run the basic underlying backbone of a video calling application).

To elaborate, the video calling library architecture 300 includes a WebRTC manager (within the layer 306) to incorporate the open source library of functions available in WebRTC. In addition, the video calling library system 102 utilizes a signaling protocol manager and a signaling state machine (within the layer 306) to negotiate some shared state between devices in a video call (or to initiate a video call). In some cases, the signaling protocol manager and/or the signaling state machine determines or negotiates (e.g., between client devices) information including what codec should be used for the video call, how quickly video frames can/should be sent, and/or IP addresses of the client devices. For instance, the signaling state machine to ensure that the semantics of the signaling stays the same across devices.

In some embodiments, the signaling state machine (or the connection state machine) can abstract away certain (unnecessary) information from states of devices, such as state names, or what exact data is included in state information. Instead, the signaling state machine (or the connection state machine) captures the semantics of signaling in relatively few (e.g., 20-30) lines of code. For instance, the signaling state machine (or the connection state machine) negotiates a state by sending or providing a first message (e.g., by a device or by the video calling library architecture 300) and receiving a second message in response.

Similarly, the video calling library architecture 300 includes a media state machine (within the layer 306). The media state machine can abstract information from the WebRTC manager to ignore certain specifics and to focus on the semantics. Indeed, the media state machine can ensure that semantics remain consistent (e.g., between devices and/or between devices and the video calling library architecture 300). Thus, if the WebRTC manager is upgraded or changed (e.g., for a new version) at some point, the media state machine can remain the same. Indeed, the specific format or detailed information in the WebRTC manager might not matter as long as the media state manager can keep semantics the same. Likewise, for other calling libraries like PJ Media (or some other), the media state machine can enforce similar semantics even if the underlying information varies. Consequently, the video calling library system 102 can adapt to different libraries by swapping out the WebRTC manager for a different library manager in a plug-and-play fashion.

Additionally, in some embodiments, the video calling library system 102 can implement or apply the media state machine and the signaling state machine of the video calling library architecture 300 independently of each other. For example, the media state machine can be one process, and the signaling state machine can be another process. Thus, the video calling library system 102 can utilize the video calling library architecture 300 to negotiate a state without every making a call. Similarly, the video calling library system 102 can utilize the video calling library architecture 300 to capture and send audio/video data (e.g., frames) between client devices without caring about the state or determining various state information.

As further illustrated in FIG. 3, the video calling library system 102 utilizes the video calling library architecture 300 to coordinate between the media state machine and the signaling state machine (e.g., so they can happen at exactly the right time). More specifically, the video calling library system 102 utilizes a relatively light connection state machine (e.g., 50 to 100 lines of code) to coordinate between media and signaling. For example, the connection state machine communicates with the signaling state machine to receive a signaling method and further communicates with the media state machine (e.g., to tell the WebRTC manager) to generate a particular object. The connection state machine coordinates the interplay between the media state machine and the signaling state machine to pass information to progress the WebRTC and the signaling protocol along their respective states to set up encoders, decoders, determine bandwidths to use, and performing other functions.

As further illustrated in FIG. 3, the video calling library architecture 300 includes the layer 304 which includes additional features or video calling functions not part of the core functions stored in the layer 306. For instance, the video calling library architecture 300 can include additional video calling functions such as co-watching, screen sharing, AR/VR capabilities, breakout sessions, selective mute functions, dominant speaker determinations, commenting functions, or other non-essential video calling functions. In some embodiments, the video calling library architecture 300 includes the layer 304 as an SDK layer on top of the layer 306 of core video calling functions. As shown, the layer 304 includes video calling functions for a camera, a call, an SDK API/dispatcher, and other functions.

In some embodiments, the video calling library system 102 can utilize a FLUX architecture to access, add, remove, and modify video calling functions in the layer 304 in a modular way. In certain cases, this architecture further enables optimizing (e.g., reducing size and increasing speed) for binary size, which is critical for lightweight applications such as Messenger Lite or Facebook Lite. With this modular, plug-and-play capability, the video calling library system 102 can flexibly adapt video calling applications for fast, efficient use on client devices, excluding bloat or unnecessary (e.g., unused) features. Indeed, rather than simply disabling unused or incompatible features for certain devices or platforms, the video calling library system 102 can utilize the video calling library architecture 300 to remove or exclude the video calling functions from the binary of the video calling application entirely (thereby saving server and device storage).

As further illustrated in FIG. 3, the video calling library architecture 300 communicates with (or includes in some embodiments) the certain plugin video calling functions of the video calling application 302. To elaborate, the code of video calling functions included in the layer 306 and the layer 304 generally does not change. However, certain applications or platforms require certain changes to video calling applications, such as how a device sends messages and how a device displays a UI and how a device manages a camera on the device. For example, some devices have multiple cameras while others only have a single camera. Additionally, some devices have extra microphones or other pieces of hardware not found on other devices.

Thus, the video calling library system 102 utilizes the video calling library architecture 300 to facilitate plug-and-play functionality to add and remove video calling functions associated with specific applications (e.g., the video calling application 302). As shown, the video calling application 302 includes application-specific or platform-specific (or device-specific or operation-system-specific) video calling functions such as call binding logic, plugins setup, transport/messaging protocols, and proxy implementation. The video calling library system 102 combines or facilitates communication between those functions of the video calling application 302 and those in the layers 304 and 306 to generate a final video calling application that includes a complete set of video calling functions. The video calling library system 102 can thus dynamically compile (e.g., by downloading only those additional video calling functions required or requested, excluding those that are not required/requested/compatible) a video calling library depending on OS, application, device capabilities, and other factors—without having to change the underlying library (e.g., core video calling functions).

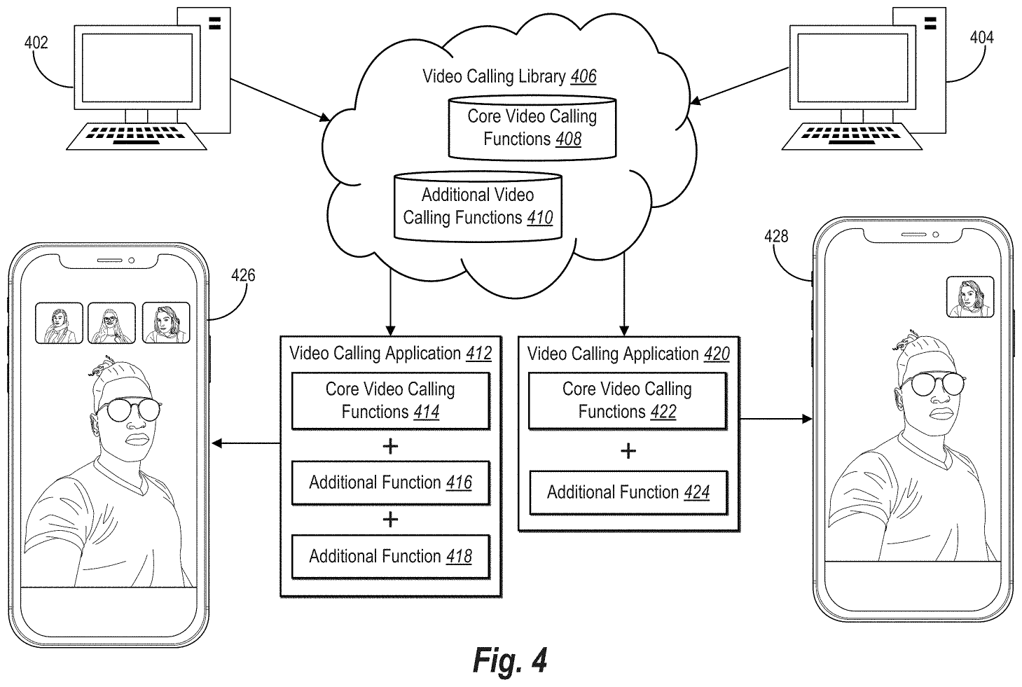

As mentioned, in certain embodiments, the video calling library system 102 generates and provides video calling applications to client devices. In particular, the video calling library system 102 provides one version of a video calling application to one client device and provides another version of the video calling application to another client device. FIG. 4 illustrates generating and providing different video calling applications to different client devices in accordance with one or more embodiments.

As illustrated in FIG. 4, the video calling library system 102 utilizes a video calling library 406 to generate or update a video calling application 412 and a video calling application 420. In particular, the video calling library system 102 generates the video calling application 412 for distribution to a client device 426 and further generates the video calling application 420 for distribution to the client device 428. In some cases, the client device 426 has higher capability (and/or better network conditions) than the client device 428, and therefore the video calling library system 102 generates the video calling application 412 to include more features than the video calling application 420. In these or other cases, the video calling application 412 is a more feature-rich version of the video calling application 420. In some embodiments, however, the video calling application 412 and the video calling application 420 are entirely different applications within different products but that still utilize the same core video calling functions.

Indeed, as shown, the video calling library system 102 generates the video calling application to include a set of core video calling functions 414 and further generates the video calling application 420 to include a set of core video calling functions 422 (e.g., the same as the core video calling functions 414). As shown, the video calling library system 102 accesses the core video calling functions 408 to generate the core video calling functions 414 and 422 as described herein. In some embodiments, the video calling library system 102 further generates the video calling application 412 to include two additional video calling functions: additional function 416 and additional function 418. Conversely, the video calling library system 102 generates the video calling application 420 to include a single additional video calling function: additional function 424. In generating the video calling applications 412 and 420, the video calling library system 102 determines capabilities, platforms, operating systems, device types, geographic areas, network conditions, and other information for the client devices 426 and 428. The video calling library system 102 thus determines which additional video calling functions are required and/or compatible and downloads them (e.g., from the additional video calling functions 410) to include within the video calling application 412.

In some embodiments, the video calling library system 102 generates the video calling applications 412 and 420 in response to receiving a request from a developer device 402. For example, the video calling library system 102 receives a request from the developer device 402 to add a new feature to a video calling application installed on the client device 426. In response, the video calling library system 102 accesses the video calling library 406 and updates the video calling application 412 to include the new feature (e.g., from the additional video calling functions 410). In some cases, the video calling library system 102 communicates with multiple developer devices such as the developer device 402 and the developer device 404 to receive different requests for generating or modifying (different versions or types of) video calling applications. In response to the one or more requests, the video calling library system 102 generates the video calling applications 412 and 420 for distribution to (e.g., to make available for download by or to push to) the client devices 426 and 428. As shown in FIG. 4, the client device 426 displays a UI for the video calling application 412 with more features (e.g., a group call) than the UI of the video calling application 420 displayed on the client device 428 (e.g., a p2p call).

In some embodiments, the video calling library system 102 can include additional video calling functions as pluggable features. For example, the video calling library system 102 utilizes selects and/or FLUX to configure a particular build depending on constraints. In some cases, the video calling library system 102 utilizes the FLUX architecture for runtime pluggability. To elaborate, at runtime, the video calling library system 102 can determine to include or exclude video calling functions based on an indication of which features/functions to include or exclude. The video calling library system 102 enables a developer device to write instructions specific to video calling functions for the video calling applications and then plugs them in.

In one or more embodiments, the video calling library system 102 indicates and/or coordinates between different participant states of client devices. For example, the video calling library system 102 determines participant states for client devices engaging in a video call. In some embodiments, the video calling library system 102 utilizes particular enum values to indicate various events during a video call, and the video calling library system 102 further updates a UI for various states based on the events that transpire.

In some embodiments, the transitions and meaning of each state are not explicitly captured by a state machine. However, the video calling library system 102 modifies some values as part of the state machine transitions. For P2P video calling, the video calling library system 102 provides a caller view and a callee view to client devices on the video call. For the caller view, the video calling library system 102 the video calling library system 102 determines state transitions differently for a self user device than for a peer device. For a self user device, the video calling library system 102 performs the following: i) starts with a negotiating state, ii) transitions to a connecting state based on an answer event, iii) and transitions to a connected state based on a WebRTC callback for a particular state change (e.g., IceConnectionStateChange). For a peer device, the video calling library system 102 performs the following: i) starts with a contacting state, ii) transitions to a ringing state based on an offer_ack event (e.g., an offer acknowledgement), and iii) transitions to a connected state based on an answer event.

Similarly, for the callee view, the video calling library system 102 determines state transitions differently for a self user device than for a peer device. For a self user device, the video calling library system 102 performs the following: i) starts with a ringing state, ii) transitions to a connecting state based on an accept event, and iii) transitions to a connected state based on a WebRTC callback for a particular state change (e.g., IceConnectionStateChange). For a peer device, the video calling library system 102 performs the following: i) starts with an unknown state and ii) transitions to a connected state based on an offer event.

For edge cases in P2P video calling, the video calling library system 102 determines certain transitions in certain edge cases. For the pranswer edge case, the video calling library system 102 may fire the WebRTC callback for IceConnectionStateChange before a user accepts. In the caller view of this case, the self user will be in the negotiating state with pranswer even if WebRTC is connected. In addition, the video calling library system 102 will transition the self user device to a connected state only after WebRTC callback for IceConnectionStateChange and receipt of an answer event from a peer device. The peer device will be in the ringing state until the answer event is received.

In the callee view of the pranswer case, the self user device will be in the ringing state until an accept event. The video calling library system 102 may skip the connecting state and go directly to a connected state based on an accept event. The video calling library system 102 will transition the peer device to a connected state with pranswer.

For a call drop edge case, the video calling library system 102 may fire the drop call event due to the WebRTC callback for IceConnectionStateChange when a network connection is lost. The video calling library system 102 transitions a self user device to a connecting state based on a drop event. The video calling library system 102 also transitions the self user device back to a connected state based on reestablishing the network connection.

For MW video calling, the video calling library system 102 determines state transitions for a caller view and a callee view. Within a caller view, the video calling library system 102 determines transitions for self user devices and for peer devices. For self user devices, the video calling library system 102 performs the following: i) starts with a negotiating state, ii) transitions to a connecting state based on an answer event, and iii) transitions to a connected state based on a WebRTC callback for IceConnectionStateChange. For peer devices, the video calling library system 102 performs the following: i) starts with a contacting state and ii) transitions to a disconnected state based on leaving a call (transitions are based on CUS given by MWS).

Within the callee view, the video calling library system 102 likewise determines state transitions for self user devices and peer devices. For self user devices, the video calling library system 102 performs the following: i) starts with a ringing state, ii) transitions to a negotiating state based on an accept event, iii) transitions to a connecting state based on an answer event, and iv) transitions to a connected state based on a WebRTC callback for IceConnectionStateChange. For peer devices, the video calling library system 102 performs the following: i) starts with an unknown state and ii) transitions to a disconnected state based on leaving a call (transitions are based on CSU given by MWS).

For edge cases in MW video calling, the video calling library system 102 facilitates certain transitions. For example, the video calling library system 102 utilizes the same behavior for call drop cases as in P2P video calling. For the case of adding a participant to a video call, the video calling library system 102 adds a participant device with a contacting state when added (transitions are based on CSU given by MWS). For the SMU case, participant devices transition to a connected state if they are part of SMU (have a media track) or if CSU gives their state as connected (this is done to reconcile the different sources of information for participants states coming from SMU and CSU). There is no pranswer edge case for MW.

### Providing Augmented Reality Environments within Video Calls

As mentioned above, the video calling library system 102 facilitates an AR video call system that can enable video calls with AR background environments. Indeed, in one or more embodiments, the AR video call system causes one or more participant client devices of a video call to render AR background environments. In some cases, the AR video call system also causes a participant client device to display different viewpoints (or portions) of an AR background space upon detecting movement on the client device (and/or upon detecting movement of a participant captured on video via the client device).

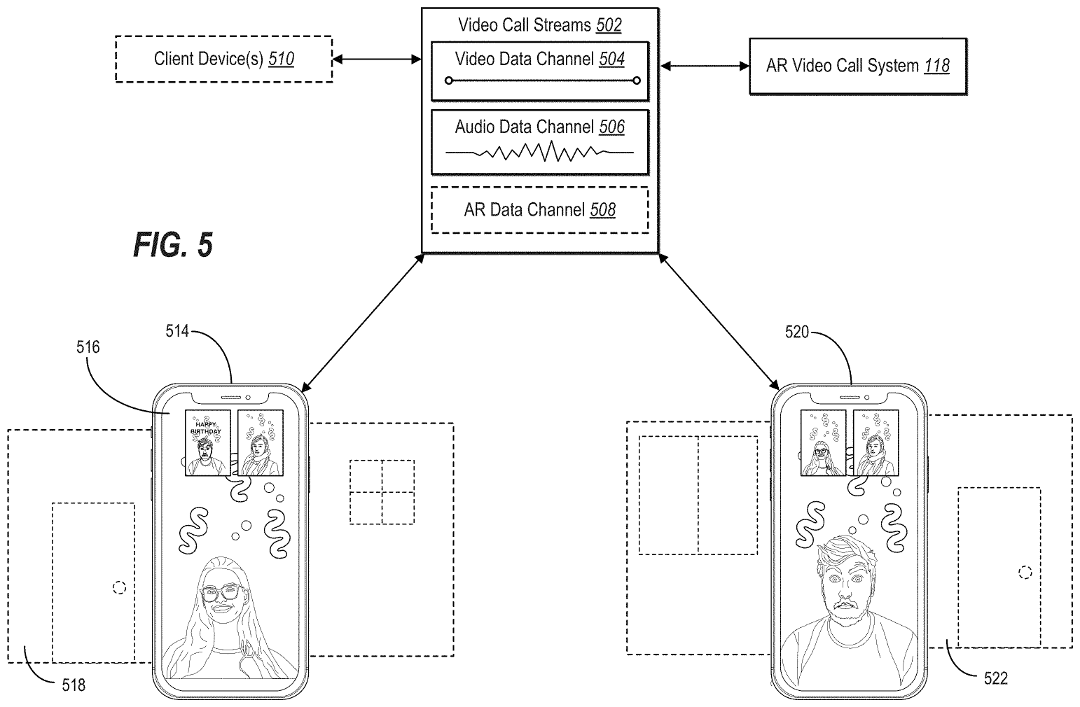

For example, FIG. 5 illustrates an AR video call system 118 establishing a video call between participant client devices with an AR background environment (within video call interfaces). As shown in FIG. 5, the AR video call system 118 can cause a client device 514 to render an AR background environment (e.g., a 360 AR background environment) that replaces a background of a captured video on the client device 514. For example, as shown in FIG. 5, the AR video call system 118 establishes a video call between a client device 514, 520 (and 510) by establishing video call streams 502 which includes a video data channel 504 and an audio data channel 506 (and, in some cases, an AR data channel 508). As shown in FIG. 5, the rendered AR background environment includes an on-screen portion 516 of a 360-degree space and an off-screen portion 518 of the 360-degree space. In one or more embodiments, the AR video call system 118 can render various portions of the on-screen portion 516 and the off-screen portion 518 of the 360-degree space upon detecting movement of the client device 514. Moreover, as shown in FIG. 5, a rendered AR background environment on the client device 520 also includes an off-screen portion 522 of an AR space (e.g., the client device 520 rendering a same or different AR background environment during the video call).

As further shown in FIG. 5, the client devices 514, 520 render AR background environments and generate video streams to transmit over the video call streams 502. As illustrated in FIG. 5, the client devices 514, 520 (and 510) can each utilize a video data channel 504 to transmit video streams of participants with one or more rendered AR background environments in the background (to the other client devices) during a video call. Moreover, in some cases, the client devices 514, 520 (and 510) can each utilize an audio data channel 506 to transmit audio streams of participants (to the other client devices) during the video call.

In one or more embodiments, a singular client device participating in the video call renders an AR background environment and captures a video stream to send over a video data channel to other client devices participating in a video call. In some instances, the client device solely renders an AR background environment to depict a participant captured on a camera of the client device within the AR background environment while other participant client devices stream the original captured video of other participants during a video call. In some embodiments, multiple participant client devices can render separate and different AR background environments and capture video streams to send over a video data channel to other client devices participating in a video call.

In some instances, multiple client devices participating in the video call renders separate and similar AR background environments and captures a video stream to send over a video data channel. In particular, in some cases, the client devices render separate AR background environments that depict the same (or similar) AR background space. Indeed, the AR video call system 118 can enable the client devices to render separate AR background environments that create a similar AR background space across the participant device videos to create the perception that the participants of the video call are in the same space.

In one or more embodiments, the AR video call system 118 can enable the client devices 514, 520 (and 510) to utilize an AR data channel 508 to share data corresponding to a synchronized AR background environment or one or more other AR effects. For example, the AR video call system 118 can enable client devices participating in a video call to transmit (or share) augmented reality data to render a synchronized AR background environment, such as, but not limited to, AR element identifiers, AR element information, logic data objects, object vectors, and/or participant identifiers.

Additionally, as shown in FIG. 5, the AR video call system 118 enables a shared AR effect (e.g., birthday confetti) between the client devices 514, 520 via the AR data channel 508. In some cases, a client device can transmit AR data (such as an AR identifier) via an AR data channel to other client devices on a video call to initiate an AR effect on the video call. In addition, upon receiving the AR data, the one or more client devices render an AR effect during the video call (as described above) while also rendering a 360 AR background environment.

Indeed, the AR video call system 118 can enable the client devices 514, 520 (and 510) to render shared AR effects through the AR data channel 508. In some cases, the AR video call system 118 enables the client device to interact with an AR environment and/or objects in the AR environment such that the interactions are reflected within the AR environment scenes of one or more of the individual participating client devices by transmitting data of the interactions through the AR data channel 508. In some embodiments, the AR video call system 118 enables AR objects to move or transition between an AR environment (e.g., an AR background environment) in a video call between a plurality of participant client devices. Additionally, the participant client device can utilize the AR data channel 508 to render and interact with AR objects between the plurality of client devices for one or more AR activities (e.g., an AR-based game, an AR-based painting canvas, sending AR effects, such as birthday confetti, balloons) during a video call by utilizing the AR data channel 508.

Additionally, although FIG. 5 illustrates a certain number of client devices participating in a video call, the AR video call system 118 can establish a video call between various numbers of client devices. In addition, the AR video call system 118 can also enable various numbers of client devices to render AR background environments during the video call.

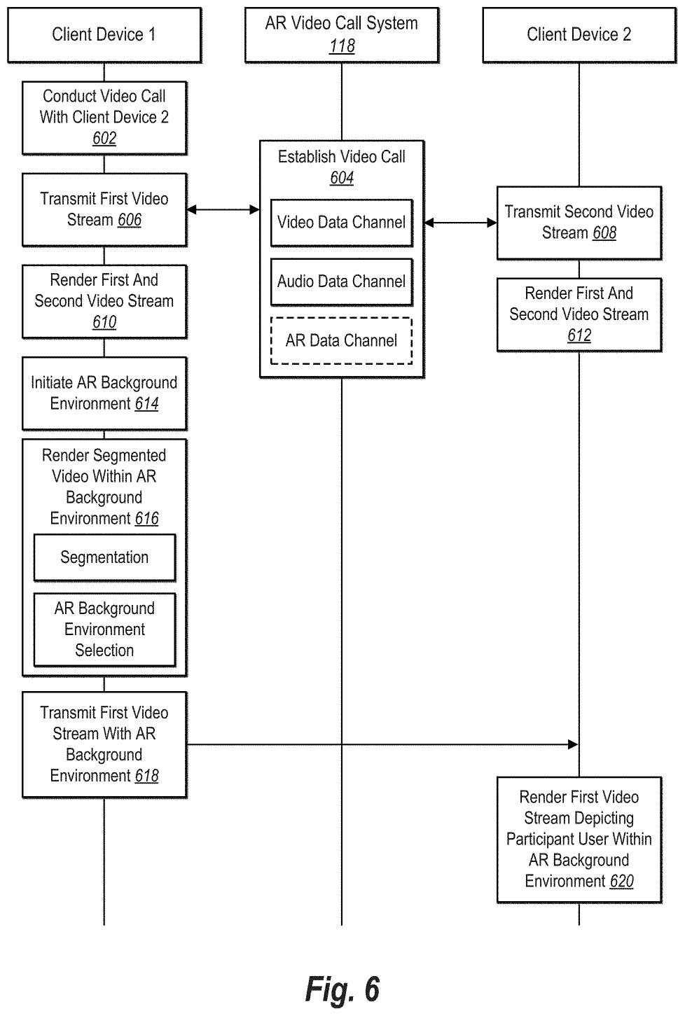

Additionally, FIG. 6 illustrates a flow diagram of the AR video call system 118 establishing a video call and a client device rendering an AR background environment during the video call. For instance, as shown in FIG. 6, the AR video call system 118 receives, in an act 602, a request to conduct a video call with a client device 2 from a client device 1 (e.g., a request to initiate a video call). Subsequently, as shown in act 604 of FIG. 6, the AR video call system 118 establish a video call between the client device 1 and the client device 2 (e.g., which includes a video data channel, an audio data channel, and, in some cases, an AR data channel). In some instances, the AR video call system 118 can facilitate the client devices to render (or share) AR effects through the AR data channel as described above.

As further shown in act 606 of FIG. 6, the client device 1 transmits a first video stream (e.g., a video stream captured on the client device 1) to the client device 2 through the video data channel and the audio data channel. Furthermore, as shown in act 608 of FIG. 6, the client device 2 transmits a second video stream (e.g., a video stream captured on the client device 2) to the client device 1 through the video data channel and the audio data channel. Furthermore, as shown in act 610 of FIG. 6, the client device 1 renders the first and second video stream. Likewise, as shown in act 612 of FIG. 6, the client device 2 also renders the first and second video stream.

Additionally, as shown in act 614 of FIG. 6, the client device 1 receives a request to initiate an AR background environment. As shown in act 616, the client device 1 renders a segmented video (from the first video stream) within an AR background environment. Indeed, as illustrated in the act 616, the client device 1 utilizes segmentation and an AR background environment selection to render the segmented video within the AR background environment.

Moreover, as shown in act 618, the client device 1 transmits the first video stream with the rendered AR background environment to the client device 2 during the video call. Indeed, as illustrated in act 620 of FIG. 6, upon receiving the first video stream with the rendered AR background environment, the client device 2 renders the first video stream depicting one or more participant users within the AR background environment. Although not shown in FIG. 2, in one or more embodiments, the client device 2 can also render a segmented video (captured on the client device 2) within an AR background environment selected on the client device 2.

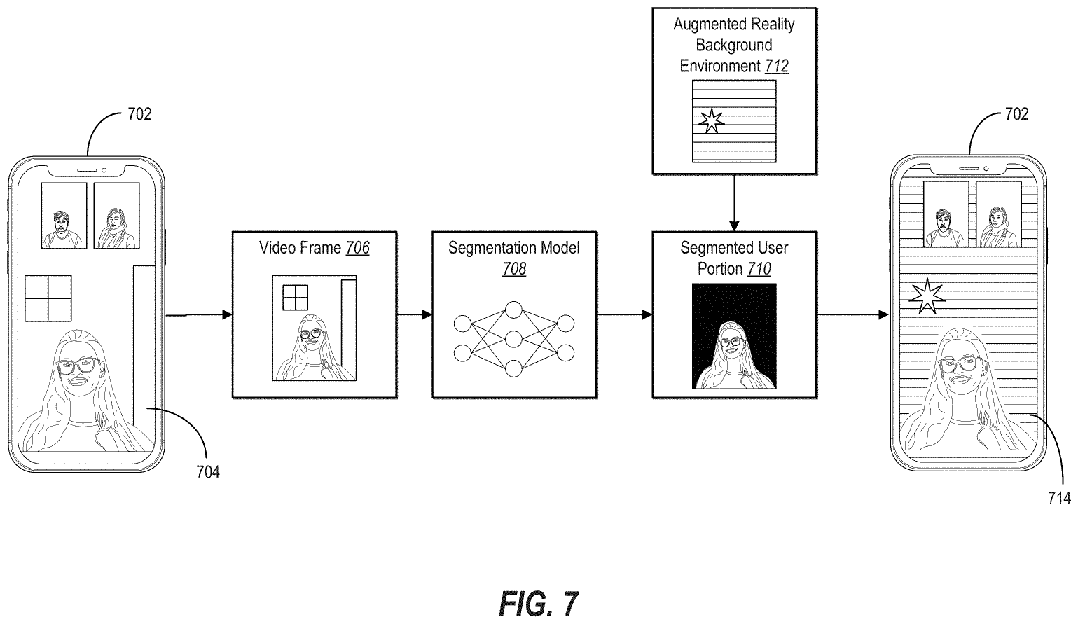

As mentioned above, the AR video call system 118 can enable client devices to render videos within AR background environments (that replace the background of the videos). For example, FIG. 7 illustrates the AR video call system 118 enabling a client device to segment a background and a foreground depicting a participant from a video to render the foreground segmented portion within an AR background environment. Indeed, FIG. 7 illustrates a client device rendering a video within a 3D AR space.

As shown in FIG. 7, a client device 702 establishes a video call with one or more other participant devices. Indeed, as illustrated in FIG. 7, the client device 702 captures and renders a video 704 of a participant user utilizing a camera corresponding to the client device 702. Moreover, as shown in FIG. 7, the AR video call system 118 (e.g., via the client device 702) utilizes a segmentation model 708 with a video frame 706 (from the video 704) to generate a segmented user portion 710. Indeed, as shown in FIG. 7, the AR video call system 118 generates the segmented user portion 710 from the video frame 706 to segment a foreground depicting a participant user from a background of the video.

Moreover, as shown in FIG. 7, the AR video call system 118 can render the segmented user portion 710 of the video within an AR background environment. For instance, as shown in FIG. 7, the AR video call system 118 identifies an augmented reality background environment 712 (e.g., as a cube mapping texture or a sphere mapping texture). Indeed, the augmented reality background environment 712 can include various AR background environments described herein (e.g., 360 AR background environments or other multi-view AR background environments). Then, as illustrated in FIG. 7, the AR video call system 118 places the segmented user portion 710 from the video frame 706 within the augmented reality background environment 712 to render a video 714 with an AR background environment.

In some embodiments, the AR video call system 118 can enable a client device to render an AR background environment as a sphere having a texture or one or more graphical objects (e.g., a 360-degree panoramic image or graphical object). For example, a client device can render an AR background environment as a spherical graphical object (e.g., a hemisphere that includes textures or graphical objects or using sphere mapping). For instance, in one or more embodiments, the AR video call system 118 can enable client devices to render AR (background) spaces utilizing hemisphere or semi-hemisphere texture mapping. Indeed, the client device can render various portions of the hemisphere texture mapping as a 3D AR space during the video call during movement of participant user device.

In some instances, the client device can render an AR background environment utilizing cube mapping (e.g., environment mapping six sides of a cube as a map shape to project a 360-video projection or 360 graphical projection). In particular, the client device can utilize six sides of a cube as a texture map for various regions of a 3D AR space. Moreover, the client device can utilize a viewpoint corresponding to a client device to render a scene of the 3D AR space from each side of the cube map relative to the viewpoint.

In some embodiments, to render an AR background environment, a client device utilizes video processing data. For instance, a client device can utilize video (or image) segmentation to segment background features from a foreground (e.g., depicting a captured participant) in the video (or video frames). Then, the client device can render an AR background environment and replace the segmented background features with visual elements of the AR background environment.

In one or more embodiments, the client device (or the AR video call system 118) utilizes a segmentation model to segment background features from a foreground of a video. Indeed, the AR video call system 118 can enable a client device to utilize various segmentation model-based approaches and/or tools to render an AR background environment that replaces a background of a video, such as, but not limited to face tracking, image masks, and/or machine learning-based segmentation models or classifiers (e.g., convolutional neural networks, generative adversarial neural networks).

For instance, the client device can utilize a segmentation model that identifies faces (or persons) depicted within video frames (e.g., face tracking). Then, the client device can utilize the segmentation model to select (or create a mask) for the pixels that correspond to the identified face (or person). Indeed, the client device can segment the pixels that correspond to the identified face (or person) and generate a layer (e.g., a segmented portion) from the pixels that correspond to the identified face (or person).

As an example, the AR video call system 118 can enable a client device to utilize a machine learning-based segmentation model to identify a salient foreground (representing a participant user) within a captured video. Indeed, in some cases, the client device utilizes a machine learning-based segmentation model that classifies subjects (e.g., salient objects) portrayed within a digital image or video frame. For instance, the machine learning-based segmentation model can classify pixels corresponding to a person depicted within a video as part of a salient object (e.g., a person) and label the pixels (e.g., using a masking layer, using pixel positions). Moreover, the client device can also utilize the machine learning-based segmentation model to classify pixels of a background as belonging to a background. Then, the AR video call system 118 can partition regions representing the salient foreground from a background of the captured video using the classification data from the machine learning-based segmentation model.

Furthermore, the AR video call system 118 can replace the background of the captured video by inserting the segmented foreground of the captured video within a rendered AR space (e.g., a 360 AR space). In some instances, the AR video call system 118 can enable a client device to generate a video layer from the segmented foreground depicting a participant user (e.g., a segmented user portion). Then, the client device can insert the video layer depicting the participant user as a foreground of a 3D AR space (e.g., a background AR space).

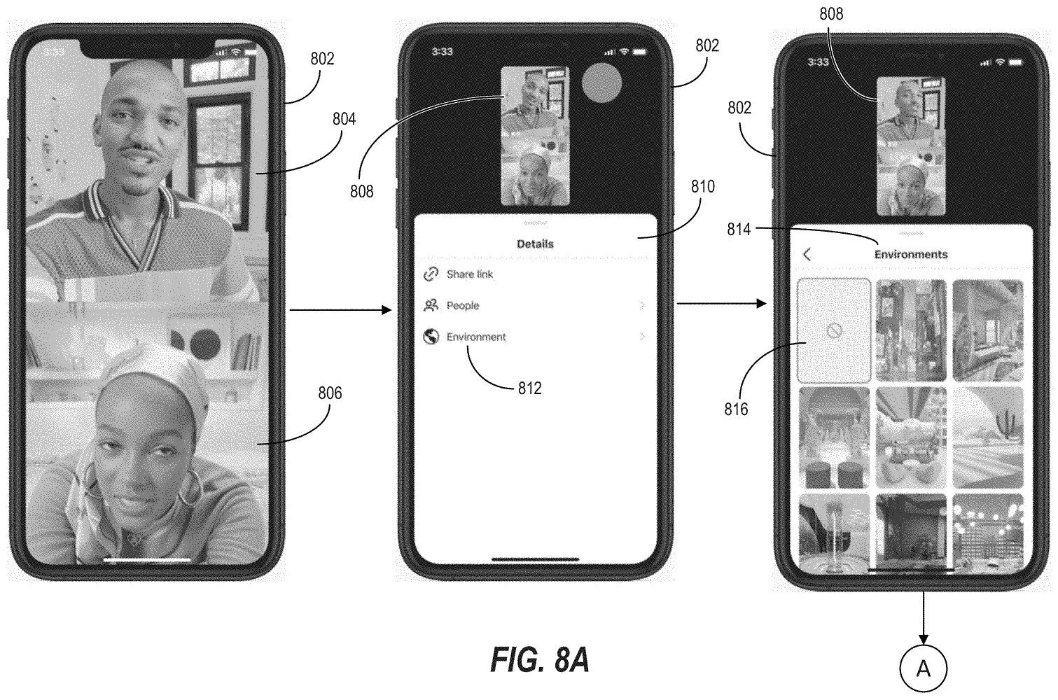

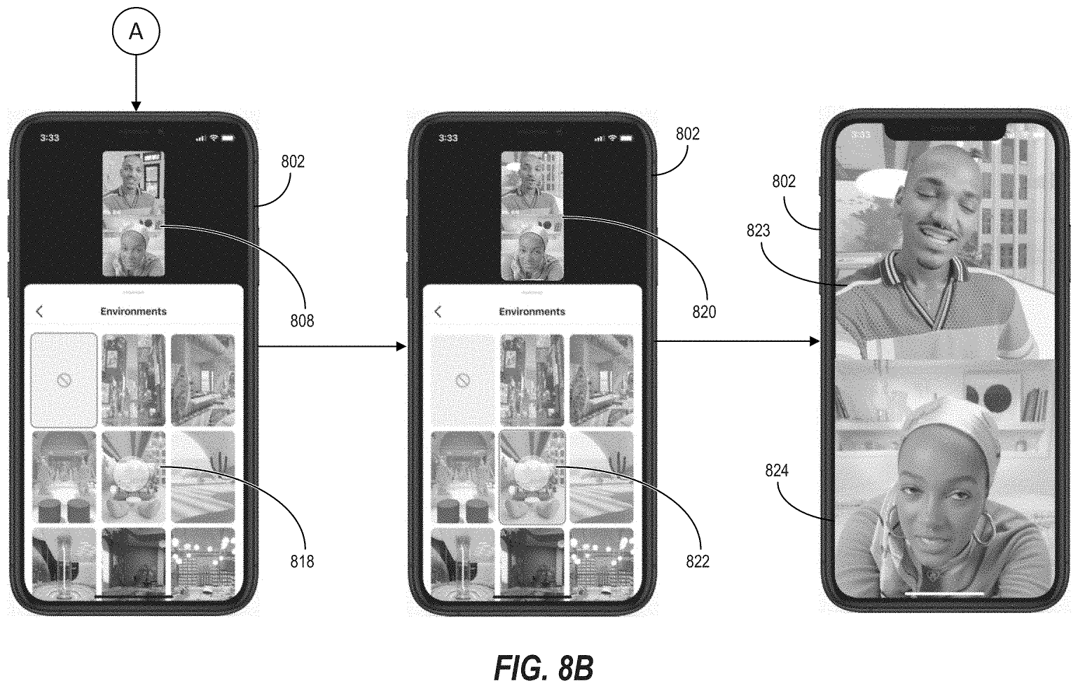

In one or more embodiments, the AR video call system 118 can provide, to client devices, graphical user interfaces for selectable options to enable the client devices to initiate an AR background environment (or 3D AR space) during a video call. For example, FIGS. 8A and 8B illustrate a client device initializing an AR background environment through one or more selectable options. As shown in FIG. 8A, a client device 802 establishes a video call with another participant (corresponding to another client device) to display a video stream 804 and a video stream 806. Furthermore, as illustrated in FIG. 8A, upon receiving a user interaction within the video call interface, the client device 802 can provide, for display within the video call interface, a menu interface 810 with selectable options (e.g., share link, people, environment) for the video call. Additionally, as shown in FIG. 8A, upon receiving a user interaction with the selectable option “Environment,” (e.g., selectable option 812) the client device 802 can provide, for display within the video call interface, a menu interface 814 with selectable AR background environments. As shown in FIG. 8A, the selected environment 816 indicates that an AR space is not selected. Accordingly, as shown in FIG. 8A, the client device 802 displays video call streams 808 with the originally captured backgrounds during the video call.

Furthermore, as shown in the transition from FIG. 8A to FIG. 8B, the client device 802 receives a selection of a particular 360 AR background environment (or 3D AR space) from the selectable 360 AR background environments 818 and renders the selected 3D AR space. For example, upon receiving selection of the particular AR background environment 822, the client device 802 renders the particular AR background environment as a background space in the video streams 820 on the client device 802 (e.g., instead of the original background of the video streams 808). For instance, as shown in FIG. 8B, the client device 802 renders a video 823 within a portion of the 3D AR space (corresponding to the selected AR background environment 822) and renders a video 824 (from another participant device) with the original background of the video stream from the participant client device.

In some cases, the other participant client device (e.g., the participant device communicating with the client device 802 during the video call) can also provide, for display within a video call interface, selectable options to select an AR background environment. Upon receiving a selection of an AR background environment, the other participant client device can render the selected AR background environment and render a video of a segmented participant user within the selected AR background environment. Indeed, the other participant client device can further transmit a video stream depicting the participant user within the selected AR background environment to the client device 802 (or additional client devices) during the video call.

In one or more embodiments, the selectable AR background environments can include user created AR background environments (e.g., 360 AR background environments or other multi-view AR background environments). For instance, the AR background environments can include AR background environments created by application developers, businesses, or individual users (e.g., utilizing graphical assets with an API corresponding to the AR video call system 118). Additionally, although FIGS. 8A and 8B illustrate a client device displaying a particular menu interface for the AR background environments, the client device can display various types and/or layouts of menu interfaces, such as, side scrolling selectable options, swiping AR background environments directly on the captured video, buttons with text describing the AR background environments.

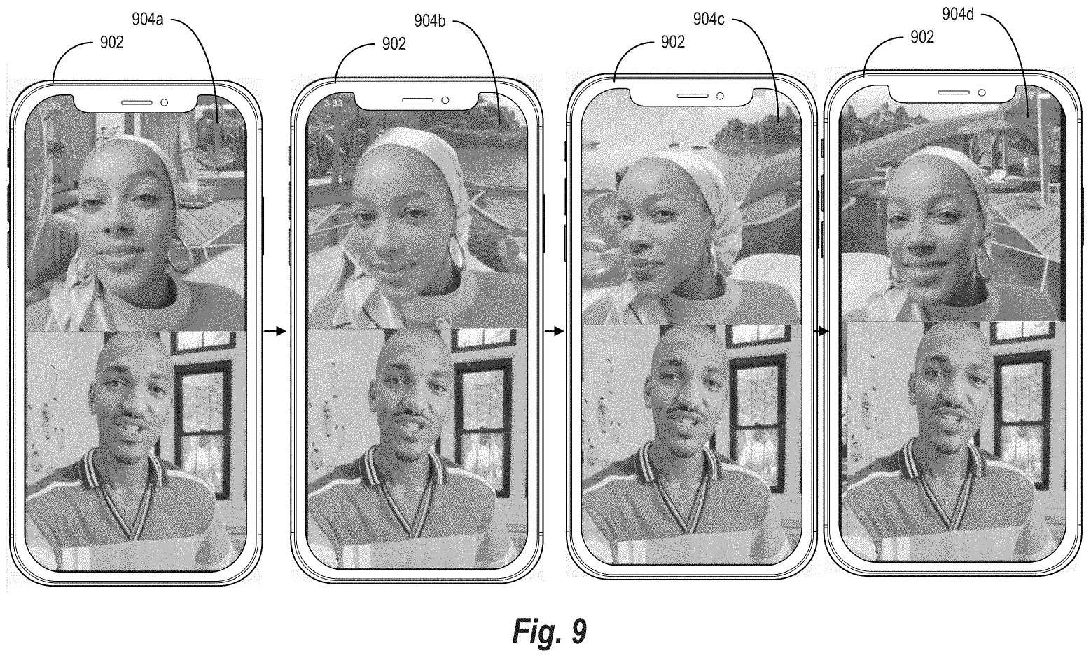

As mentioned above, the AR video call system 118 can enable a client device to track movement of the client device (and/or movement of a participant) and update a rendering of an AR background environment (e.g., a 360 AR background environment or other multi-view AR background environment) based on the tracked movement. For example, FIG. 9 illustrates a client device 902 utilizing tracked movements to update a rendering of a 360 AR background environment during a video call. For example, as shown in FIG. 9, the client device 902 detects movement of the client device 902 (e.g., from the participant user holding the client device 902) and updates the rendering of the 360 AR background environment to simulate a multi-degree (e.g., 360 degree) space (e.g., different portions of a beach house space). Indeed, as shown in FIG. 9, the movement of the client device 902 causes the client device 902 to render a different portion of the 360 AR background environment to simulate that the camera of the client device is facing (and capturing) a different portion of the 360-degree space (e.g., movement from a portion 904a of the AR space, to portions 904b, 904c, and 904d of the AR space).

Although FIG. 9 illustrates movement of a single client device, the AR video call system 118 can enable more than one participant client device on the video call to detect movement and update a corresponding rendering of a 360 AR background environment based on the detected movement (in the respective participant client device).

Additionally, although one or more implementations herein describe utilizing a 360 AR background environment that includes a 360-degree viewing angle, the AR video call system 118 can enable client devices to render AR background environments having various viewing angles. For instance, the AR video call system 118 can enable a client device to render an AR background environment having a 180-degree viewing angle or a 270-degree viewing angle.

In some instances, the AR video call system 118 can enable a client device to detect movement utilizing sensors within the client device. For example, the client device can utilize motion sensors, such as gyroscopes and/or accelerometers to detect a movement and orientation of a client device. Subsequently, the client device can utilize the movement and orientation data to change a rendered AR background environment to simulate the position of the phone and the viewing angle of the capturing camera within the 360-degree (or other multi-view) space. For example, a client device can utilize various motion sensors or other sensors to detect movement and/or orientation of the client device, such as, but not limited to a gyroscope sensor, accelerometer sensor, infrared sensor, camera, and/or inertial measurement unit (IMU) sensor.

Furthermore, as previously mentioned, the AR video call system 118 can maintain a persistent 360 AR background environment for a client device (or between participants or client devices of participants) in subsequent video calls. For example, the AR video call system 118 can save (or remember) an AR background environment selection and/or modifications to the AR background environment for a client device (or between participant devices of a video call). Furthermore, upon receiving or initiating a video call via a participant device (e.g., with the same participant device(s) or with each video call), the AR video call system 118 can initiate the video call with the saved AR background environment.

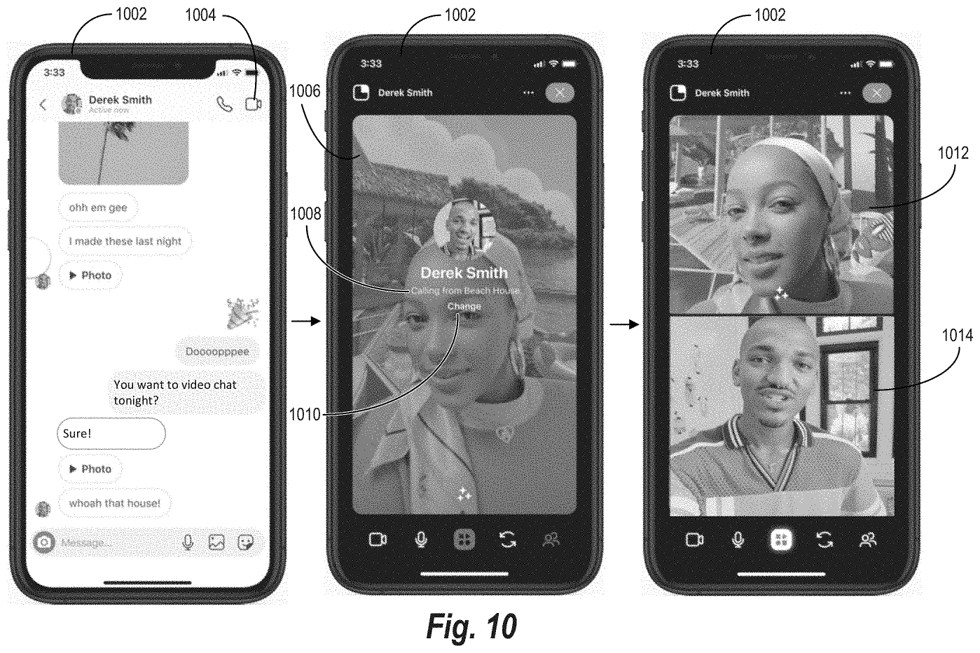

For example, FIG. 10 illustrates a client device 1002 initiating a video call with a persistent AR background environment. As shown in FIG. 10, the client device 1002 receives a user interaction with a selectable option 1004 indicating a request to establish a video call with another participant. Upon initiation of the video call, the client device 1002 provides, for display within a video call interface 1006 (e.g., a video call initiation interface), an indication 1008 that a particular AR background environment (e.g., a Beach House) is rendered (or will be rendered during the video call). Indeed, the particular AR background environment can include a persistent AR background environment that has been utilized in previous video calls by the client device 1002 and/or between the participants of the video call (e.g., the participant users as shown in FIG. 10).

As further shown in FIG. 10, the client device 1002 also provides, for display within the video call interface 1006, a selectable option 1010 to change the persistent AR background environment. Indeed, upon receiving a selection of the selectable option 1010 to change the AR background environment, the client device 1002 can display, within a menu interface, selectable AR background environments (as described above) to change the AR background environment for the client device 1002 during the video call. In some cases, the client device 1002 can provide, for display, selectable options to change AR background environments for the current video call or for each video call (e.g., changing a persistent AR background environment). In some cases, the client device 1002 can provide, for display, menu options to change a persistent AR background environment during a video call waiting interface and/or during the video call.

In some embodiments, the AR video call system 118 (or a client device) can utilize themes from other communication mediums (e.g., a messenger application, an email application, a virtual reality space) to select a persistent AR background environment. For example, the client device can determine that a messenger communication thread between participants (or a group of participants) utilizes a particular theme (e.g., beach house, outer space, forest). The client device, upon receiving a request to establish a video call, can utilize the particular theme to initiate a video call with an AR background environment that corresponds to (or matches the) particular theme.

Moreover, in some cases, the AR video call system 118 can also maintain persistence of the AR background environment within other communication mediums. For example, the AR video call system 118 can generate a virtual reality space from the AR background environment (and various modifications from participant devices) when a participant user corresponding to the AR background environment joins a virtual reality space. For example, the AR video call system 118 can provide, for a display, a virtual reality version of the AR space in which one or more participant users can communicate via an extended-reality device.

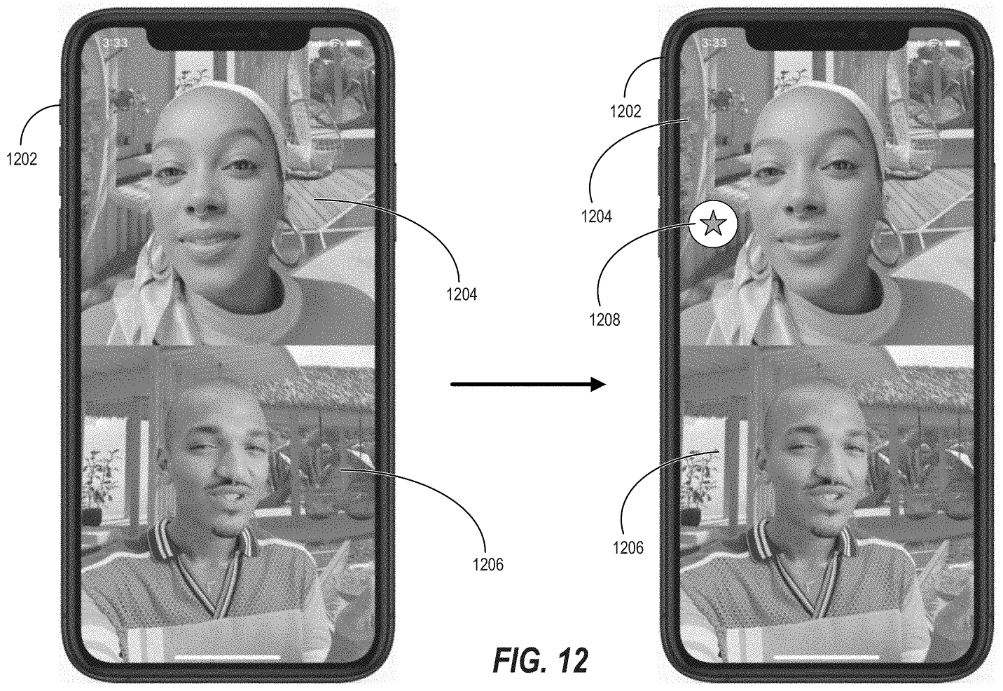

In addition, the AR video call system 118 can also maintain persistent AR effects, AR objects, and/or other modifications within an AR background environment. For example, the AR video call system 118 can save AR object placements or other modifications within (or to) the AR background environment for a client device (or between a particular group of participant client devices). Then, upon initiation of a video call by the client device (or between the particular group of participant client devices), the AR video call system 118 can enable the client device to render the AR background environment with the saved (or persistent) AR object placements or other modifications within (or to) the 360 AR background environment. For example, the AR video call system 118 can save AR effects and/or modifications to the AR background environment introduced in the AR background environment as described below (e.g., in relation to FIG. 12).

As further shown in FIG. 10, upon initiating the video call, the client device 1002 renders a video of a participant user (e.g., segmented user) within a portion 1012 of a 3D AR space (e.g., the AR background environment from the indication 1008) during the video call. In addition, the client device 1002 can also transmit a video stream to another participant device (e.g., corresponding to the video 1014) depicting the participant user captured on the client device 1002 within the portion 1012 of the 3D AR space. In one or more embodiments, the AR video call system 118 also causes the other participant device to render the video of the other participant and transmit a video stream to the client device 1002.

In some implementations, the AR video call system 118 also enables a client device to layer various AR effects or visual elements during a video call having an AR background environment. For example, the AR video call system 118 can enable a client device to render an AR background environment and also render another AR element within the AR background environment during a video call. For instance, the client device can render (or impose) an AR element on a participant depicted within a captured video in addition to rendering the AR background environment in the background. Indeed, the client device can modify a depiction of a participant captured within a video or replace the participant with a visual element within the AR background environment during the video call.

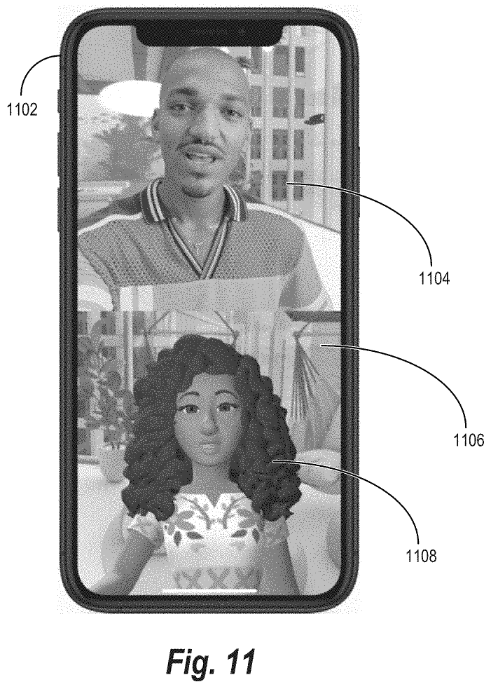

As an example, FIG. 11 illustrates the AR video call system 118 enabling a client device 1102 to layer an AR effect on an AR background environment video call by imposing an avatar 1108 (as an AR element) of a participant within a rendered AR background environment 1106. As shown in FIG. 11, the client device 1102 renders the avatar 1108 of the participant within the AR background environment 1106 that also mimics mannerisms and actions of the participant as captured on video during the video call. Indeed, the AR video call system 118 can enable a client device to render the AR background environment (as described herein) while also rendering an avatar that follows movements and actions of the captured participant in real time. Moreover, as shown in FIG. 11, the client device 1102 also displays a video 1104 of another participant device.

Additionally, although FIG. 11 illustrates a single participant (via a participant device) utilizing an avatar within a video call, the AR video call system 118 can enable multiple participant client devices to render avatars for corresponding participants. For example, the AR video call system 118 can enable various client devices to render avatars within AR background environments rendered on the various client devices. In some cases, multiple client devices can render avatars of participants captured on the client devices and streams captured videos of the avatars within various AR background environments (and/or originally captured backgrounds). In one or more embodiments, the AR video call system 118 enables the multiple client devices to render avatars and transmit data for the avatars via an AR data channel to cause participant client devices to (natively) include (or impose) avatars as textures within a locally rendered AR background environment.

Moreover, although FIG. 11 illustrates a client device utilizing an avatar within a video call over the AR background environment 1106, the AR video call system 118 can enable the client device 1102 to introduce a variety of AR effects on a participant. For example, the AR video call system 118 can enable a client device to render AR effects, such as, but not limited to, AR makeup, AR face cleanup, AR sunglasses, AR beards on the captured video of the participant. Indeed, the AR video call system 118 can enable the client device to render such AR effects on top of the AR background environment. To illustrate, in one or more embodiments, the AR video call system 118 enables a client device to render a variety of AR effects (e.g., as filters) that modify an appearance of a participant user captured within a video (while rendering an AR background environment). For example, the client device can render AR effect-based filters that brighten a face of a participant, add make up to a participant, and/or change a hairstyle of a participant (e.g., using AR-based hair). In some cases, the client device can render AR effect-based filters that modify an appearance of an AR background environment (e.g., change lighting of an AR background environment, change colors of an AR background environment). Indeed, the AR video call system 118 can enable a client device to render various AR-based filters in accordance with one or more implementations herein.

Indeed, in one or more embodiments, the AR video call system 118 can enable a client device to utilize or render various video textures from videos within AR effects (or avatars). In one or more implementations, a client device can capture video during a video call and also capture video processing data to track one or more faces portrayed in the captured video, identify backgrounds (e.g., segmentation data), generate masks, and/or other data from the video (e.g., color data, depth information) using the captured video (and onboard sensors of the client device). Moreover, the AR video call system 118 can enable the client device to render videos of individual participants as video textures within AR effects utilizing the video data and the video processing data. In one or more implementations, the AR video call system 118 enables the client devices to render video textures per participant such that multiple participants captured on the same client device are rendered as separate video textures within the AR scene of the video call.

In one or more embodiments, the AR video call system 118 enables a client device to render a video of a participant as a video texture as an avatar that is displayed within an AR background environment (e.g., a three- or two-dimensional environment). For example, the AR video call system 118 can enable a client device to utilize video processing data to impose facial movements on an avatar corresponding to the participant. Then, the AR video call system 118 can enable the client device to display the avatar (with live actions from a video stream of the participant) as an AR effect and/or within a 3D AR scene (e.g., an AR background environment).

Additionally, as previously mentioned, the AR video call system 118 can enable a client device to receive user interactions from a participant to interact with and/or modify an AR background environment (e.g., a 360 AR background environment or various multi-view AR background environments) during a video call. For example, a client device can receive a user interaction to modify an AR background environment (via user interactions) by inserting visual effects (or objects), such as, but not limited to paintings, drawings, writing, text, AR objects (e.g., AR furniture, AR vehicles, AR animals) within the AR background environment. For instance, FIG. 12 illustrates a client device receiving a user interaction to modify an AR background environment.

As shown in FIG. 12, during a video call, a client device 1202 can receive a user interaction (e.g., a selection of an option to add an AR object, to paint, to draw) within a portion of an AR background space 1204 during a video call with another participant user device that is capturing and streaming an additional video. Indeed, a user interaction can include a touch or tap interaction on the screen of the client device 1202 (e.g., after selecting a visual effect or directly drawing the visual effect on the AR background environment). Upon receiving the user interaction, as shown in FIG. 12, the client device 1202 can modify a rendered portion of the AR background space 1204 (e.g., a 360 AR background environment) to include a visual effect 1208 introduced by the user interaction (e.g., a painting depicting a star is place on the wall depicted in the rendered AR background environment). Moreover, as shown in FIG. 12, the client device 1202 also displays a video 1206 of another participant device.

Moreover, the AR video call system 118 can enable the modifications or visual effects added to the AR background environment to be persistent. In particular, the AR video call system 118 can save the modifications or visual effects such that they are maintained (and are displayed) in the AR background environment in subsequent video calls by the client device 1202 (or between the same participants). In some cases, the AR video call system 118 can indicate or access an AR background environment to a host participant such that the AR background environment is persistent whenever the same host participant initiates a video call or initiates a video call with a variety of other participants (e.g., a home AR space).

Indeed, the AR video call system 118 can enable client devices to receive user interactions to modify or add a variety of visual effects in an AR background environment. For example, the AR video call system 118 can enable an AR background environment to include user added (or created) visual effects, such as, paintings, stickers, artwork, whiteboard notes, AR objects (e.g., AR furniture, AR carpets, AR plants, AR animals) via modifications and/or selections of visual effects.

Additionally, in one or more embodiments, the AR video call system 118 enables a client device to render various shared AR effects (as described above) while also rendering an AR background environment. For example, the AR video call system 118 can enable a client device to render AR objects that move across participant devices of the video call via the AR data channel (as described herein). Additionally, the AR video call system 118 can enable client devices to receive interactions with shared AR objects to render the shared AR object similarly across client devices (as described above) while also rendering an AR background environment. Moreover, the AR video call system 118 can enable client devices to render shared AR based games between the client devices while also rendering an AR background environment in the background.

Furthermore, in one or more embodiments, the AR video call system 118 can enable audio components to an AR background environment (e.g., a 360 AR background environment), AR effect, AR-based activity, and/or individual AR element during a video call. For example, a client device can transmit audio information (or audio identifiers) through an AR data channel such that the client devices on a video call play audio for the AR environment (e.g., ambient noises, background noises, such as waves, wind, sounds of moving AR objects), AR effect, AR-based activity, and/or individual AR element (e.g., audio related to the AR elements). In some cases, the AR video call system 118 can provide a library of audio data for one or more AR environments, AR effects, AR-based activities, and/or individual AR elements available during a video call between a plurality of client devices.

### Facilitating Payment Transactions Over a Voice Channel within Extended-Reality Environments

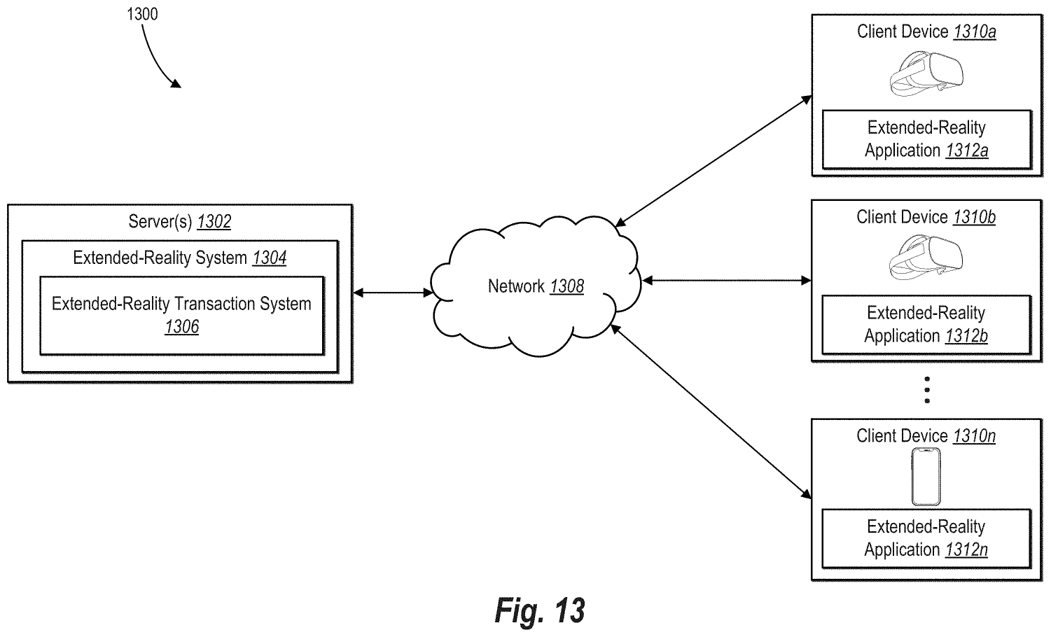

As mentioned above, the video calling library system can also facilitate or interact with an extended-reality system that implements an extended-reality transaction system. For example, FIG. 13 illustrates a schematic diagram of an exemplary system environment (“environment”) 1300 in which an extended-reality transaction system 1306 can be implemented. As illustrated in FIG. 13, the environment 1300 includes server(s) 1302 (sometimes referred to as server device(s)), a network 1308, and client devices 1310a-1310n.

Although the environment 1300 of FIG. 13 is depicted as having a particular number of components, the environment 1300 can have any number of additional or alternative components (e.g., any number of server devices and/or client devices in communication with the extended-reality transaction system 1306 either directly or via the network 1308). Similarly, although FIG. 13 illustrates a particular arrangement of the server(s) 1302, the network 1308, and the client devices 1310a-1310n, various additional arrangements are possible.

The server(s) 1302, the network 1308, and the client devices 1310a-1310n may be communicatively coupled with each other either directly or indirectly (e.g., through the network 1308 discussed in greater detail below in relation to FIGS. 22 and 23). Moreover, the server(s) 1302 and the client devices 1310a-1310n may include a variety of computing devices (including one or more computing devices as discussed in greater detail with relation to FIGS. 21 and 22).

As mentioned above, the environment 1300 includes the server(s) 1302. The server(s) 1302 can generate, store, receive, and/or transmit data including communications data for an extended-reality environment. For example, the server(s) 1302 can receive user input from a client device (e.g., one of the client devices 1310a-1310n) and transmit the communication to another client device. In one or more embodiments, the server(s) 1302 comprises a data server. The server(s) 1302 can also comprise a communication server or a web-hosting server.

As shown in FIG. 13, the server(s) 1302 include an extended-reality system 1304. In particular, the extended-reality system 1304 can provide a digital platform (e.g., an extended-reality platform) that includes functionality through which users of the extended-reality system 1304 can connect to and/or interact with one another. For example, the extended-reality system 1304 can register a user (e.g., a user of one of the client devices 1310a-1310n). The extended-reality system 1304 can further provide features through which the user can connect to and/or interact with co-users. For example, the extended-reality system 1304 can provide messaging features, chat features, video call, avatar representation in extended-reality environments, and/or audio features through which a user can communicate with one or more co-users. The extended-reality system 1304 can also generate and provide groups and communities through which the user can associate with co-users.

In one or more embodiments, the extended-reality system 1304 further implements or interacts with a social networking system which may include, but is not limited to an e-mail system, search engine system, e-commerce system, banking system, metaverse system or any number of other system types that use user accounts. For example, in some implementations, the extended-reality system 1304 generates and/or obtains data for an extended-reality device (e.g., client devices 1310a-1310n via the server(s) 1302). Furthermore, the extended-reality system 1304 can provide and/or generate virtual reality elements (e.g., graphics, audio, video, other sensory input) related to an extended-reality environment (e.g., virtual concerts, virtual immersive video games, virtual social meetups) in the extended-reality device. Additionally, the extended-reality system 1304 can manage user actions of one or more users within an extended-reality environment by receiving information (e.g., interactions, movements, communications, payment information) from one or more extended-reality devices operated by the one or more users (e.g., the client devices 1310a-1310n via the server(s) 1302).

In one or more embodiments where the extended-reality system 1304 comprises a social networking system, the extended-reality system 1304 may include a social graph system for representing and analyzing a plurality of users and concepts. A node storage of the social graph system can store node information comprising nodes for users, nodes for concepts, and nodes for items. An edge storage of the social graph system can store edge information comprising relationships between nodes and/or actions occurring within the social networking system. Further detail regarding social networking systems, social graphs, edges, and nodes is presented below with respect to FIGS. 22 and 23.

As further shown in FIG. 13, the server(s) 1302 include the extended-reality transaction system 1306. In one or more embodiments, the extended-reality transaction system 1306 facilitates payment transactions between users operating in an extended-reality environment and a real-world environment. For instance, the extended-reality transaction system 1306 can establish a secure voice channel to transmit payment information between a client device (e.g., client device 1310a) representing (or having a user operating within) an extended-reality environment and another client device (e.g., client device 1310n) representing (or having a user operating within) a real-world environment.

Additionally, as shown in FIG. 13, the environment 1300 includes the client devices 1310a-1310n. For instance, the client devices 1310a-1310n can include computing devices (as extended-reality devices) that can facilitate communication between users of a networking system via an extended-reality environment. For example, the client devices 1310a-1310n can include head-mounted display devices (including those capable of providing an extended reality display), smartphones, tablets, desktop computers, laptop computers, or other electronic devices having extended reality capabilities.

Additionally, the client devices 1310a-1310n can include one or more applications (e.g., the extended-reality applications 1312a-1312n) that can facilitate communication between users of a networking system via an extended-reality environment. For example, the extended-reality applications 1312a-1312n can include a software application installed on the client devices 1310a-1310n. Additionally, or alternatively, the extended-reality applications 1314a-1314n can include a software application hosted on the server(s) 1302, which may be accessed by the client devices 1310a-1310n through another application, such as a web browser. In addition, some client devices from the client devices 1310a-1310n can, via an extended-reality application from the extended-reality applications 1312a-1312n, communicate (e.g., via a voice channel) with a user operating within an extended-reality environment via an extended-reality device. Furthermore, in some embodiments, each of the client devices 1310n-1310n is associated with one or more user accounts of a social networking system (e.g., as described in relation to FIGS. 22 and 23).

The extended-reality transaction system 1306 can be implemented in whole, or in part, by the individual elements of the environment 1300. Indeed, although FIG. 1 illustrates the extended-reality transaction system 1306 implemented with regard to the server(s) 1302, different components of the extended-reality transaction system 1306 can be implemented by a variety of devices within the environment 1300. For example, one or more (or all) components of the extended-reality transaction system 1306 can be implemented by a different computing device (e.g., one of the client devices 1310a-1310n) or a separate server from the server(s) 1302.

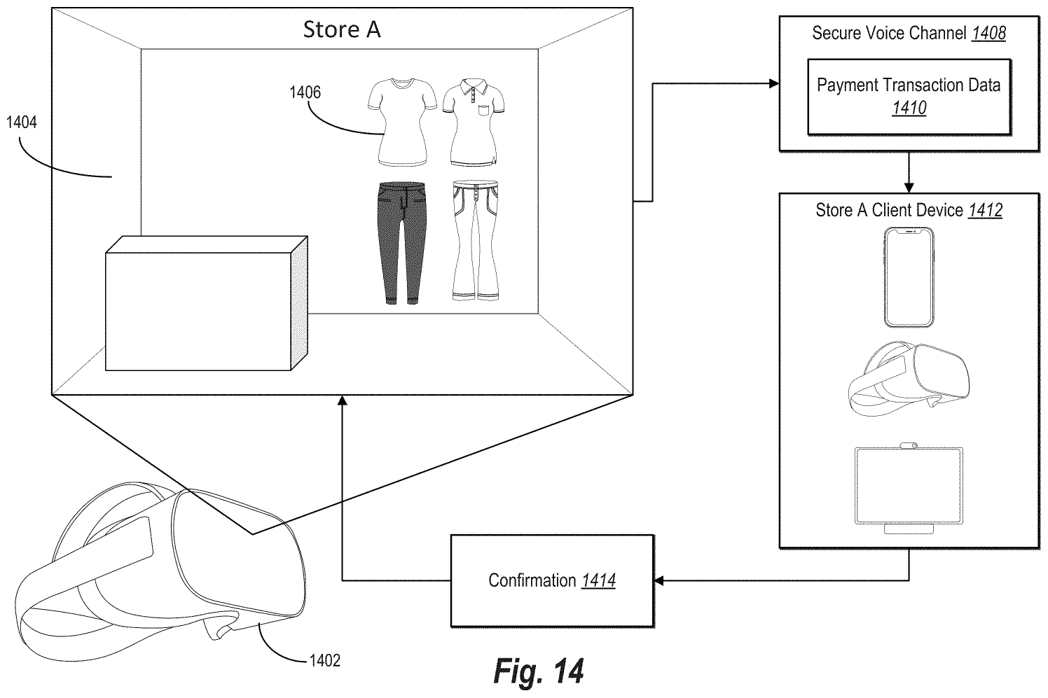

For example, FIG. 14 illustrates the extended-reality transaction system 1306 facilitating a payment transaction between an extended-reality device (of a user operating in an extended-reality environment) with a client device (of another user operating in a real-world setting). As shown in FIG. 14, an extended-reality device 1402 displays an extended-reality environment 1404 (e.g., a virtual representation of a store) to a user. In one or more embodiments, the extended-reality device 1402 enables a user to interact with or move around the extended-reality environment 1404 to view and/or interact with various graphical objects. As shown in FIG. 14, the extended-reality transaction system 1306 can receive a user interaction with the graphical object 1406 (e.g., a virtual representation of a shirt) from within the extended-reality environment 1404.

In some cases, the extended-reality transaction system 1306 can, in response to the detected user interaction with the graphical object 1406, establish a communication channel (e.g., a video call, an audio call) with a client device 1412 that is related to the store (or the graphical object 1406) represented within the extended-reality environment 1404. In some cases, during the communication between the user operating the extended-reality device 1402 and the user (e.g., a business owner, customer service agent) operating the client device 1412, the extended-reality transaction system 1306 can receive a request to initiate a payment transaction (from the client device 1412 or the extended-reality device 1402). In some instances, the request to initiate the payment transaction can be for the purchase of the graphical object 1406 or purchase of a real-world item represented by the graphical object 1406.

In particular, upon receiving the request to initiate the payment transaction, as shown in FIG. 14, the extended-reality transaction system 1306 establishes a secure voice channel 1408 between the extended-reality device 1402 and the client device 1412. Indeed, as further shown in FIG. 14, the extended-reality transaction system 1306 can facilitate the transfer or communication of payment transaction data 1410 from the extended-reality device 1402 (e.g., as provided by the user operating the extended-reality device 1402) to the client device 1412. Additionally, the extended-reality transaction system 1306 can cause (or enable) the client device 1412 to process a payment transaction using the payment transaction data 1410 upon receiving the payment transaction data 1410. Upon processing the payment, the client device 1412 (e.g., via a user operating the client device 1412) can further cause or initiate the delivery of the graphical object 1406 or purchase of a real-world item represented by the graphical object 1406 to the user of the extended-reality device 1402 and/or the user operating the extended-reality device 1402). As further shown in FIG. 14, the client device 1412 transmits a confirmation 1414 to the extended-reality device 1402 to indicate a successful payment and/or order confirmation for the delivery of the graphical object 1406 or purchase of a real-world item represented by the graphical object 1406.

Although one or more embodiments herein illustrate the extended-reality transaction system 1306 facilitating payment transactions over a voice channel within a virtual store extended-reality environment setting, the extended-reality transaction system 1306 can facilitate payment transactions in various extended-reality environment settings. For example, the extended-reality transaction system 1306 can enable voice channel payment transaction (as described herein) within extended-reality environments that represent virtual settings, such as, but not limited to, virtual art galleries (e.g., as a marketplace for digital art, real-world art, non-fungible tokens for art), virtual digital content stores (e.g., virtual video game stores, virtual application stores), and/or virtual workspaces and/or meetings (e.g., a virtual meeting with a service provider for catering, venue rental, real estate). In some embodiments, the extended-reality transaction system 1306 can enable voice channel payment transactions (as described herein) within extended-reality environments that represent entertainment venues (e.g., payment for entry or other content), such as, but not limited to, a virtual concert or a virtual stream of a real-world concert, a virtual stream of a real-world sport event, a virtual stream of a real-world convention, a virtual convention). Additionally, in some cases, the extended-reality transaction system 1306 can enable voice channel payment transactions (as described herein) within extended-reality environments between users for services, such as, but not limited to lessons (e.g., music lessons, cooking lessons), advisor meetings, and/or customer service meetings.

In one or more embodiments, the extended-reality transaction system 1306 enables communication of payment information through a secure voice channel between an extended-reality device of a user operating within (or experiencing) an extended-reality environment and a client device of a user operating within a real-world setting for purchase and delivery of a real-world product. For instance, upon completion of a payment transaction through the secured voice channel (as described herein), the client device of the user (e.g., the merchant user) can initiate a delivery of a purchased product or item (from the communication with the purchasing user interacting within the extended-reality environment) to the purchasing user. As an example, upon purchase of a product (e.g., a shirt) seen within an extended-reality environment by a purchasing user utilizing an extended-reality device in accordance with one or more implementations herein, the client device of the merchant user can initiate a delivery of the product to a physical address of the purchasing user corresponding the extended-reality device.

In addition, in some embodiments, the extended-reality transaction system 1306 enables communication of payment information through a secure voice channel between an extended-reality device of a user operating within (or experiencing) an extended-reality environment and a client device of a user operating within a real-world setting for purchase and delivery of a digital item. For example, upon completion of a payment transaction through the secured voice channel (as described herein), the client device of the user (e.g., the merchant user) can initiate a delivery or transmittal of a purchased digital product (from the communication with the purchasing user interacting within the extended-reality environment) to the extended-reality device or other client device of the purchasing user. As an example, upon purchase of a product (e.g., a music file, a video file, an NFT, software) seen within an extended-reality environment by a purchasing user utilizing an extended-reality device in accordance with one or more implementations herein, the client device of the merchant user can initiate a delivery of the product to a digital address of the purchasing user (e.g., via an email, a download source, a license code, a license in a digital content library).

Furthermore, in one or more embodiments, the extended-reality transaction system 1306 can receive a request to initiate communication between users from an extended-reality environment device (or another client device) within an extended-reality environment from various signal interactions. For example, the extended-reality transaction system 1306 can detect a user selection of an object or selectable option within the extended-reality environment displayed within an extended-reality device a request to initiate communication. In some cases, the extended-reality transaction system 1306 can detect that a user corresponding to the extended-reality device entered or is positioned within a specific virtual location (related to the other user or merchant user) in the extended-reality environment and, based on the detected virtual location, can initiate communication in accordance with one or more implementations herein. In some embodiments, the extended-reality transaction system 1306 can receive a request to communicate from the extended-reality device (e.g., via a dialer, voice command) to a client device corresponding to the virtual location or object within the extended-reality environment.

In some cases, the extended-reality transaction system 1306 enables a client device to transmit a confirmation (e.g., for the successful payment transaction and/or for information on an ordered product) upon completion of a payment transaction over the voice channel. For instance, the extended-reality transaction system 1306 can enable a client device to transmit the confirmation via an electronic communication, such as, but not limited to an email, an SMS, an instant message to the extended-reality device (or other client device) of the purchasing user. In some cases, the extended-reality transaction system 1306 can cause the extended-reality device to display a visual confirmation within the extended-reality environment upon completion of the payment transaction, such as, but not limited to an overlaid notification, a graphical receipt printed within the extended-reality environment, a graphical representation of an information screen within the extended-reality environment (e.g., a virtual monitor).

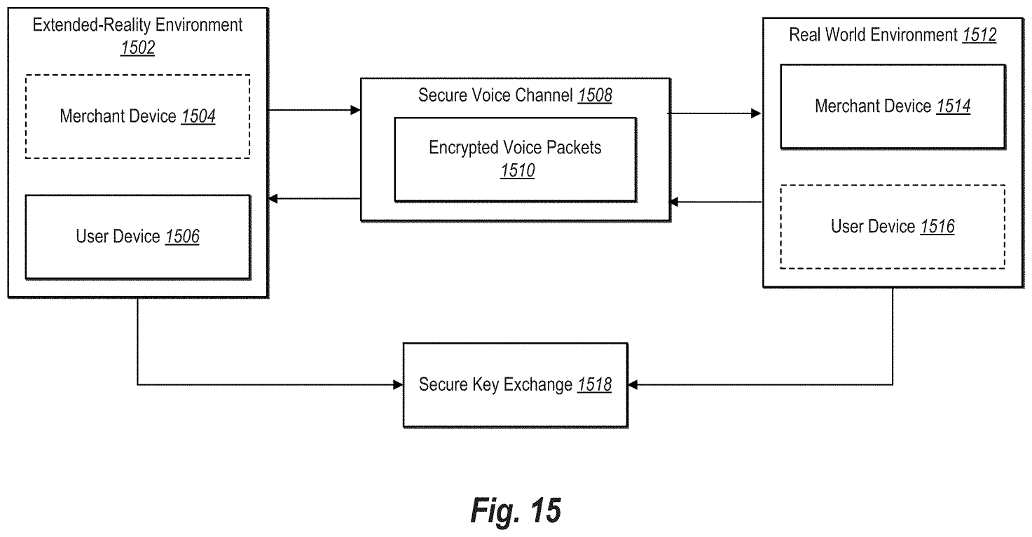

As previously mentioned, the extended-reality transaction system 1306 establishes and utilizes a secure voice channel to facilitate communication of payment information for a payment transaction between a user operating in an extended-reality environment and a user operating in a real-world environment. For example, FIG. 15 illustrates the extended-reality transaction system 1306 enabling the transmission of payment information over a secured voice channel between a user interacting within an extended-reality environment and a user operating within a real-world environment.

For example, in reference to FIG. 15, the extended-reality transaction system 1306 can receive a request to initiate a payment transaction from a merchant device 1514 (within a real-world environment 1512) in relation to a user device 1506 operating in the extended-reality environment 1502. Upon receiving the request to initiate the payment transaction, the extended-reality transaction system 1306 can establish a secure voice channel 1508. Then, the extended-reality transaction system 1306 can facilitate transmission (or communication) of payment information from the user device 1506 (of a user operating in the extended-reality environment 1502) to a merchant device 1514 (operating within the real-world environment 1512). As further shown in FIG. 15, the extended-reality transaction system 1306 enables the user device 1506 to transmit encrypted voice packets 1510 to communicate payment information to the merchant device 1514. Indeed, the encrypted voice packets 1510 are encrypted/decrypted by the user device 1506 and the merchant device 1514 utilizing an encryption key from a secure key exchange 1518 between the user device 1506 and the merchant device 1514.

Although one or more embodiments illustrate a user device of a user operating within an extended-reality environment transmitting payment information to a merchant device within a real-world environment, the extended-reality transaction system 1306 can enable payment transactions between various combinations of devices in extended-reality and/or real-world environments. For example, as shown in FIG. 15, in some cases, a merchant device 1504 of a merchant user operating within the extended-reality environment 1502 can initiate a payment transaction request from a user device 1516 operating in the real-world environment 1512. Furthermore, the extended-reality transaction system 1306 can enable the user device 1516 operating in the real-world environment 1512 to transmit (or communicate) payment information across the secure voice channel 1508 to the merchant device 1504 of a merchant user operating within the extended-reality environment 1502.

In some cases, the extended-reality transaction system 1306 can establish a secure voice channel for a payment transaction between extended-reality devices of users that are both operating within an extended-reality environment. For instance, in some cases, the extended-reality transaction system 1306 can enable a user device of a user that is operating within an extended-reality environment to communicate payment information (for a payment transaction), in accordance with one or more implementations herein, with another user device that is also operating within the extended-reality environment. In some cases, the extended-reality transaction system 1306 enables the extended-reality devices of both users to display a shared extended-reality environment with representations of both users present in the shared extended-reality environment while facilitating the communication of the payment information over the voice channel in accordance with one or more implementations herein.

Furthermore, in some embodiments, the extended-reality transaction system 1306 establishes a secured voice channel to enable the transmission of payment information (or other personal information) during a payment transaction within an extended-reality environment. In some cases, the extended-reality transaction system 1306 utilizes encrypted voice packets that encrypt audio and/or video data from one client device to another. For example, the extended-reality transaction system 1306 can utilize various voice packets between user devices, such as, put not limited to, real-time transport protocol (RTP) voice packets, RTP control protocol (RTCP), and/or secure real-time transport protocol (SRTP).

Indeed, in one or more embodiments, the extended-reality transaction system 1306 establishes a voice channel between client devices to enable end-to-end encryption between the client devices of the payment transaction (e.g., the extended-reality device and another merchant device). For example, in one or more embodiments, the extended-reality transaction system 1306 facilitates a secure key exchange between the devices that enables the exchange of encryption keys between the devices to encrypt and/or decrypt the encrypted voice packets sent over the secured voice channel. For example, in some embodiments, the extended-reality transaction system 1306 utilizes key exchange approaches, such as, but not limited to, the Diffie-Hellman key exchange, Rivest-Shamir-Adleman (RSA) key exchange, and/or Elliptic Curve Digital Signature Algorithm (ECDSA). Furthermore, the extended-reality transaction system 1306 can enable client devices to encrypt voice packets using various types of encryption algorithms, such as, but not limited to, RSA, the Advanced Encryption Standard (AES), and/or Data Encryption Standard (DES).

In one or more embodiments, the extended-reality transaction system 1306 can enable transmission of payment information across a video call channel. For example, in one or more embodiments, the extended-reality transaction system 1306 enables an extended-reality device of a user operating within an extended-reality environment to establish a video call with a client device of a user operating within a real-world environment. In addition, the extended-reality transaction system 1306 can enable the devices to encrypt and decrypt audio and video packets between the devices during an exchange (or communication) of payment information in accordance with one or more embodiments herein.

Furthermore, in one or more implementations, the extended-reality transaction system 1306 enables communication of payment information via a voice channel by transmitting communications (e.g., audio) of a user operating in the extended-reality environment speaking or dictating the payment information (e.g., credit card number, bank account number) to a client device of a user operating in the real-world environment. In some cases, the extended-reality transaction system 1306 establishes a voice channel with an automated payment information collection script to collect payment information from the user operating within the extended-reality environment. Moreover, in some cases, the extended-reality transaction system 1306 causes an extended-reality device to scan a credit card or other payment form during a video call (through a camera of the extended-reality device while operating within the extended-reality environment) and transmit the scanned information over the secure voice channel (or secure video call channel).

In some embodiments, the extended-reality transaction system 1306 enables the client devices to listen for an audio tone (e.g., a beeping sound or various other unique audio tones) to determine an initiation of a secure key exchange to establish the secure voice channel between the client devices. For instance, upon detecting the tone at one or more of the client devices, the extended-reality transaction system 1306 enables the client devices to exchange encryption keys to create an end-to-end encrypted voice channel between the client devices. Then, the extended-reality transaction system 1306 can enable the client devices to exchange payment information in accordance with one or more implementations described herein.

### Animating Avatars Utilizing Audio-Based Viseme Recognition

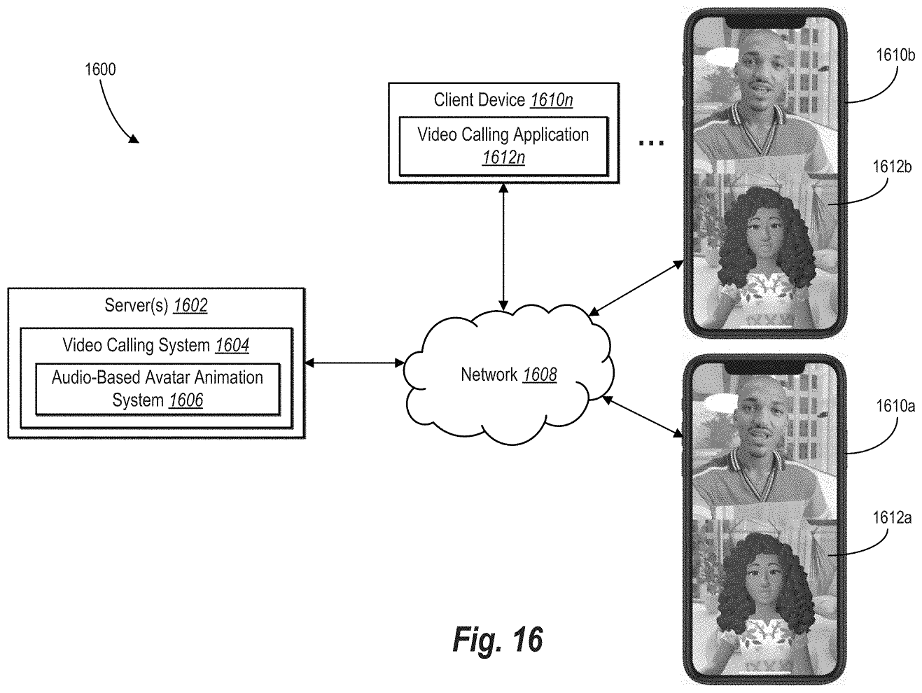

As mentioned above, the video calling library system 102 can facilitate or interact with a video call system that implements an audio-based avatar animation system. For example, FIG. 16 illustrates a schematic diagram of an exemplary system environment (“environment”) 1600 in which an audio-based avatar animation system 1606 can be implemented. As illustrated in FIG. 16, the environment 1600 includes server(s) 1602 (sometimes referred to as server device(s)), a network 1608, and client devices 1610a-1610n.

Although the environment 1600 of FIG. 16 is depicted as having a particular number of components, the environment 1600 can have any number of additional or alternative components (e.g., any number of server devices and/or client devices in communication with the audio-based avatar animation system 1606 either directly or via the network 1608). Similarly, although FIG. 16 illustrates a particular arrangement of the server(s) 1602, the network 1608, and the client devices 1610a-1610n, various additional arrangements are possible.

The server(s) 1602, the network 1608, and the client devices 1610a-1610n may be communicatively coupled with each other either directly or indirectly (e.g., through the network 1608 discussed in greater detail below in relation to FIGS. 22 and 23). Moreover, the server(s) 1602 and the client devices 1610a-1610n may include a variety of computing devices (including one or more computing devices as discussed in greater detail with relation to FIGS. 21 and 22).

As mentioned above, the environment 1600 includes the server(s) 1602. The server(s) 1602 can generate, store, receive, and/or transmit data including, but not limited to, avatar data, audio data, viseme data, viseme recognition model (e.g., audio-to-viseme model) data, and/or video data. For example, the server(s) 1602 can receive user input from a client device (e.g., one of the client devices 1610a-1610n) and transmit the communication to another client device. In one or more embodiments, the server(s) 1602 comprises a data server. The server(s) 1602 can also comprise a communication server or a web-hosting server.

As shown in FIG. 16, the server(s) 1602 include a video calling system 1604. In particular, the video calling system 1604 can provide functionality through which users of the video calling system 1604 can connect to and/or interact with one another through video and audio calls. For example, the video calling system 1604 can provide features through which the user can connect to and/or interact with co-users through captured videos and/or audios of the users on computing devices. For example, the video calling system 1604 can provide messaging features, chat features, video call, avatar representations, and/or audio features through which a user can communicate with one or more co-users.

In some embodiments, the video calling system 1604 further implements or interacts with a social networking system which may include, but is not limited to an e-mail system, search engine system, e-commerce system, banking system, metaverse system or any number of other system types that use user accounts. For example, the video calling system 1604 can provide and/or generate avatars that correspond to users (e.g., via avatar creation through user input, camera scans). Additionally, the video calling system 1604 can manage contact information of one or more users to enable the users to initiate video and/or audio calls between client devices. In one or more embodiments where the video calling system 1604 comprises a social networking system, the video calling system 1604 may include a social graph system for representing and analyzing a plurality of users and concepts (as described above and presented below with respect to FIGS. 22 and 23).

As further shown in FIG. 16, the server(s) 1602 include the audio-based avatar animation system 1606. In one or more implementations, the audio-based avatar animation system 1606 can render animated avatars utilizing visemes identified from audio data captured by a client device during a video call. Indeed, the audio-based avatar animation system 1606 can display (or cause one or more client devices participating in the video call to display) an avatar that animates detected mouth (and/or facial movements) of a user based on visemes detected from audio data of the user.

Additionally, as shown in FIG. 16, the environment 1600 includes the client devices 1610a-1610n. For instance, the client devices 1610a-1610n can include client devices that can facilitate communication between users of a networking system via audio and/or video. For example, the client devices 1610a-1610n can include smartphones, tablets, desktop computers, laptop computers, head-mounted display devices, or other electronic devices having video calling and/or audio calling capabilities.

Additionally, the client devices 1610a-1610n can include one or more applications (e.g., the video calling applications 1612a-1612n) that can facilitate audio and/or video communication between users of a networking system. For example, the video calling applications 1612a-1612n can include a software application installed on the client devices 1610a-1610n. Additionally, or alternatively, the video calling applications 1612a-1612n can include a software application hosted on the server(s) 1602, which may be accessed by the client devices 1610a-1610n through another application, such as a web browser. Furthermore, in some embodiments, each of the client devices 1610n-1610n is associated with one or more user accounts of a social networking system (e.g., as described in relation to FIGS. 22 and 23).

For example, as shown in FIG. 16, the video calling system 104 establishes a video call between the client device 1610a and the client device 1610b. The client device 1610a does not turn on the camera or selects an audio only option. As further shown in FIG. 16, the audio-based avatar animation system 1606 can utilize audio data from the client device 1610a to animate a rendered avatar on the video call between the client device 1610a and the client device 1610b in place of displaying a blank square (as done by conventional systems when an audio only option is selected). In some implementations, the video calling system 104 (and the audio-based avatar animation system 1606) can establish a video call with audio-animated avatars (as described herein) with various numbers of client devices (e.g., from the client devices 1610a-1610n).

The audio-based avatar animation system 1606 can be implemented in whole, or in part, by the individual elements of the environment 1600. Indeed, although FIG. 16 illustrates the audio-based avatar animation system 1606 implemented with regard to the server(s) 1602, different components of the audio-based avatar animation system 1606 can be implemented by a variety of devices within the environment 1600. For example, one or more (or all) components of the audio-based avatar animation system 1606 can be implemented by a different computing device (e.g., one of the client devices 1610a-1610n) or a separate server from the server(s) 1602.

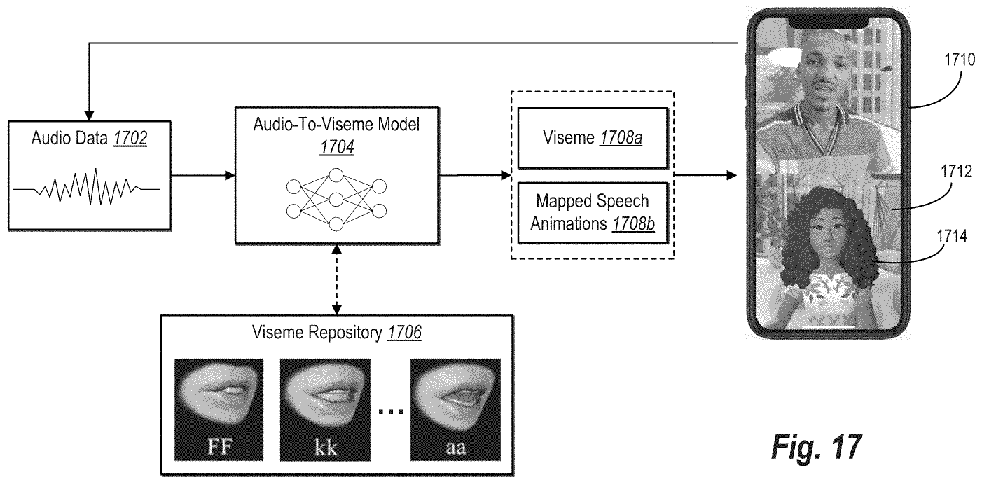

As previously mentioned, the audio-based avatar animation system 1606 can render an animated avatar depicting speech a user utilizing audio data captured on a client device during a video call. For example, FIG. 17 illustrates the audio-based avatar animation system 1606 determining visemes from audio data during a video call. Furthermore, FIG. 17 also illustrates the audio-based avatar animation system 1606 utilizing determined visemes to render an animated avatar that depicts mouth and/or facial movements that map to the visemes spoken by the user utilizing the client device (e.g., to mimic the likely facial movements made by the user during the video call).

To illustrate, as shown in FIG. 17, the audio-based avatar animation system 1606 enables a client device 1710 (participating in a video call 1712) to capture audio data 1702 from a participant user. Moreover, as shown in FIG. 17, the audio-based avatar animation system 1606 utilizes the audio data 1702 with an audio-to-viseme model 1704 to predict (or determine) speech visemes from the audio data. Indeed, as shown in FIG. 17, the audio-based avatar animation system 1606 utilizes a viseme repository 1706 with the audio-to-viseme model 1704 to determine and select visemes and corresponding mouth shapes (e.g., mapped speech animations) from the audio data 1702. Subsequently, the audio-based avatar animation system 1606 utilizes the selected viseme(s) 1708a and/or mapped speech animation(s) 1708b to animate an avatar 1714 corresponding to the user operating and speaking via the client device 1710 during the video call. Indeed, in reference to FIG. 17, the audio-based avatar animation system 1606 can enable the client device 1710 to continuously detect audio data, determine visemes and mapped speech animations, and animate the avatar based on the visemes and/or mapped speech animations during the video call.

In one or more embodiments, the audio-based avatar animation system 1606 utilizes an audio-to-viseme model. For instance, the audio-based avatar animation system 1606 can utilize an audio-to-viseme model that map audio data to visemes and/or speech animations (e.g., mouth movements or shapes, facial movements or shapes, check movements or shapes) that map to visemes. In some cases, the audio-based avatar animation system 1606 can utilize an audio-to-viseme model that predicts (or classifies) visemes and/or speech animations from audio data.

In certain instances, the audio-based avatar animation system 1606 can utilize an audio-to-viseme model that utilizes a mapping between various audio sounds to visemes and/or speech animations to select a viseme and/or speech animation for input audio data. Furthermore, in one or more embodiments, the audio-based avatar animation system 1606 utilizes an audio-to-viseme model that utilizes a machine learning model trained to predict viseme and/or speech animation mappings to input audio data. As an example, the audio-based avatar animation system 1606 can utilize an audio-to-viseme model that utilizes various machine learning models or classifiers, such as, but not limited to, convolutional neural networks, generative adversarial neural networks, recurrent neural networks configured (or trained) to predict or label visemes and/or speech animations for input audio data.

Furthermore, in one or more embodiments, the audio-based avatar animation system 1606 utilizes a viseme repository for an audio-to-viseme model. In particular, the audio-based avatar animation system 1606 can utilize a viseme repository that includes various visemes and modelled speech animations for the visemes. For example, the modelled speech animations can include depictions and/or mappable animations or meshes that depict mouth movements or shapes, facial movements or shapes, check movements or shapes for various visemes. Indeed, the audio-based avatar animation system 1606 can select one or more (e.g., as a sequence) visemes and speech animations from the viseme repository to utilize with an avatar to animate the avatar.

To illustrate, in some cases, the audio-based avatar animation system 1606 can utilize determined visemes and speech animations to animate mouth and/or lip movements of an avatar to depict the avatar speaking the input audio data. In addition, the audio-based avatar animation system 1606 can also utilize the determined visemes and speech animations to animate face movements (e.g., eye movement, eyebrow movement, cheek movement, chin movement, nose movement) to depict the avatar speaking the input audio data. Indeed, the audio-based avatar animation system 1606 can utilize the visemes and speech animations to render an animated avatar that puppets (or mimics) visual expressions that portray the avatar speaking the audio data captured by a client device.

Additionally, in certain implementations, the audio-based avatar animation system 1606 utilizes various sounds from the audio data to animate various additional movements in an avatar during a video call. For example, the audio-based avatar animation system 1606 can identify breathing sounds from audio data and utilize the breathing sounds to animate breathing for the avatar (e.g., via animated movements of an avatar's shoulders, hair, head, nose). In some cases, the audio-based avatar animation system 1606 can identify laughter sounds from the audio data and utilize the laughter sounds to animate laughter for the avatar (e.g., via animated movements of an avatar's shoulders, hair, head, mouth, eyes, hands). Additionally, as another example, the audio-based avatar animation system 1606 can identify yawning sounds from the audio data and utilize the yawning sounds to animate yawning for the avatar (e.g., via animated movements of an avatar's shoulders, hair, head, mouth, eyes, hands).

In some cases, the audio-based avatar animation system 1606 can determine (or identify) a sentiment or emotion from the audio data. Furthermore, the audio-based avatar animation system 1606 can utilize the identified sentiment or emotion to animate emotion for an avatar during a video call. For instance, upon determining happiness or joyfulness from the audio data, the audio-based avatar animation system 1606 can animate an avatar to smile or be in a joyful state (e.g., via animated movements of an avatar's shoulders, hair, head, mouth, eyes, hands) during the video call. In some cases, upon determining sadness from the audio data, the audio-based avatar animation system 1606 can animate an avatar to frown or be in a sad state (e.g., via animated movements of an avatar's shoulders, hair, head, mouth, eyes, hands) during the video call.

Additionally, the audio-based avatar animation system 1606 can also render additional animations for the avatar during the video call to depict realism in the avatar. For example, the audio-based avatar animation system 1606 can animate randomized blinking and/or breathing for an avatar. In addition, the audio-based avatar animation system 1606 can animate randomized hair movement and/or hand gesturing for the avatar during the video call.

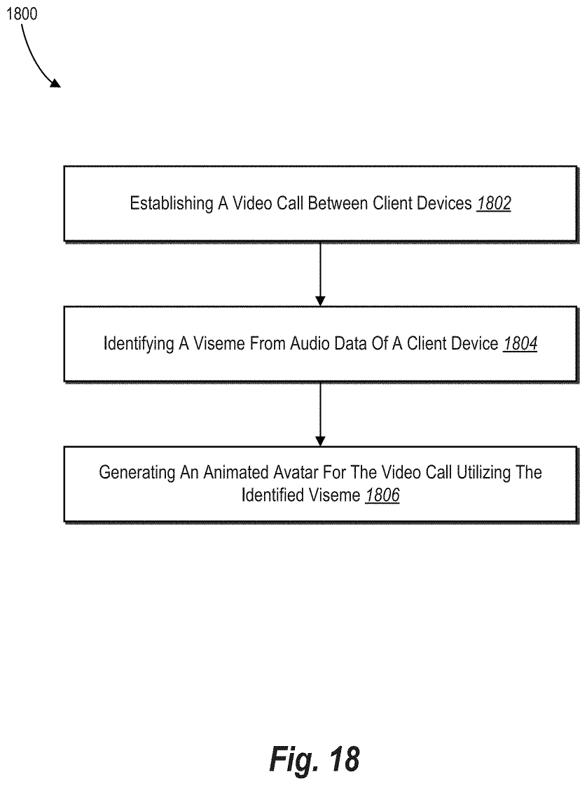

FIGS. 1-17, the corresponding text and the examples provide a number of different methods, systems, devices, and non-transitory computer-readable media of various systems or implementations of the video calling library system 102 (e.g., the AR video call system 118, the extended-reality transaction system 1306, the audio-based avatar animation system 1606). In addition to the foregoing, one or more embodiments can also be described in terms of flowcharts comprising acts for accomplishing particular results, as shown in FIGS. 18-20. FIGS. 18-20 may be performed with more or fewer acts. Furthermore, the acts shown in FIGS. 18-20 may be performed in different orders. Additionally, the acts described in FIGS. 18-20 may be repeated or performed in parallel with one another or in parallel with different instances of the same or similar acts.

For example, FIG. 18 illustrates a flowchart of a series of acts 1800 for animating an avatar (during a video or audio call) using audio data in accordance with one or more implementations. While FIG. 18 illustrates acts according to one or more embodiments, alternative embodiments may omit, add to, reorder, and/or modify any of the acts shown in FIG. 18. In some implementations, the acts of FIG. 18 are performed as part of a method. Alternatively, a non-transitory computer-readable medium can store instructions thereon that, when executed by at least one processor, cause a computing device to perform the acts of FIG. 18. In some embodiments, a system performs the acts of FIG. 18. For example, in one or more embodiments, a system includes at least one processor. The system can further include a non-transitory computer-readable medium comprising instructions that, when executed by the at least one processor, cause the system to perform the acts of FIG. 18.

As shown in FIG. 18, the series of acts 1800 includes an act 1802 of establishing a video call between client devices. Furthermore, as shown in FIG. 18, the series of acts 1800 includes an act 1804 of identifying a viseme from audio data of a client device. Moreover, as shown in FIG. 18, the series of acts 1800 includes an act 1806 of generating an animated avatar for the video call utilizing the identified viseme.

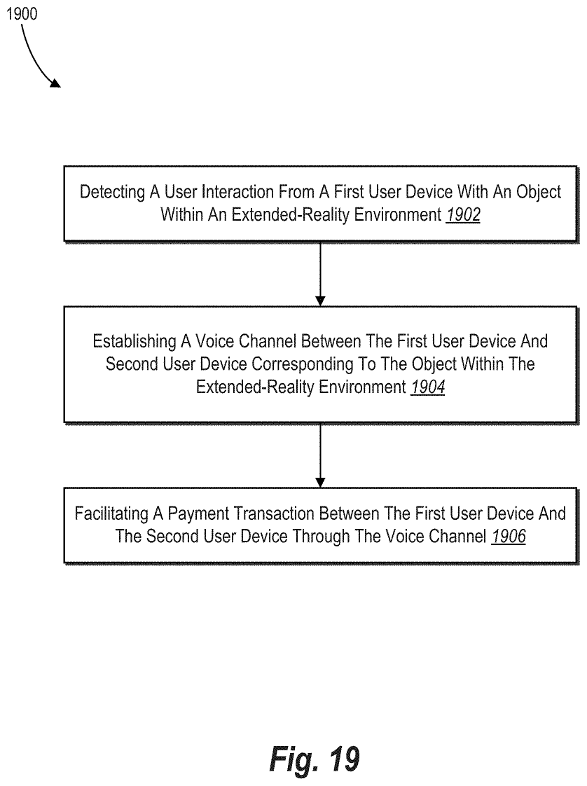

Furthermore, FIG. 19 illustrates a flowchart of a series of acts 1900 for enabling secure voice-based payments between a device facilitating a user interaction within an extended-reality device and another device facilitating a user interaction within a real-world environment in accordance with one or more implementations. While FIG. 19 illustrates acts according to one or more embodiments, alternative embodiments may omit, add to, reorder, and/or modify any of the acts shown in FIG. 19. In some implementations, the acts of FIG. 19 are performed as part of a method. Alternatively, a non-transitory computer-readable medium can store instructions thereon that, when executed by at least one processor, cause a computing device to perform the acts of FIG. 19. In some embodiments, a system performs the acts of FIG. 19. For example, in one or more embodiments, a system includes at least one processor. The system can further include a non-transitory computer-readable medium comprising instructions that, when executed by the at least one processor, cause the system to perform the acts of FIG. 19.

As shown in FIG. 19, the series of acts 1900 includes an act 1902 of detecting a user interaction from a first user device with an object within an extended-reality environment. Furthermore, as shown in FIG. 19, the series of acts 1900 includes an act 1904 of establishing a voice channel between the first user device and a second user device corresponding to the object with in the extended-reality environment. Moreover, as shown in FIG. 19, the series of acts 1900 includes an act 1906 of facilitating a payment transaction between the first user device and the second user device through the voice channel.

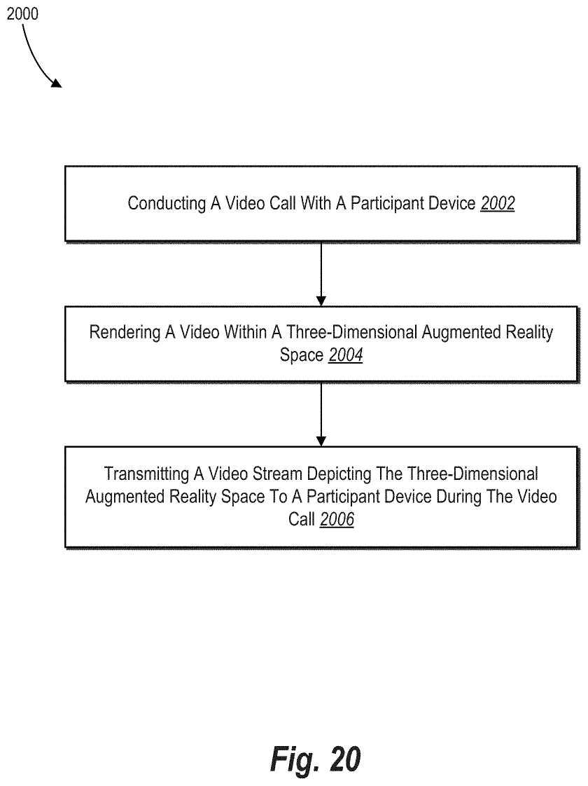

Furthermore, FIG. 20 illustrates a flowchart of a series of acts 2000 for enabling video calls which facilitate augmented reality (AR) background environments in accordance with one or more implementations. While FIG. 20 illustrates acts according to one or more embodiments, alternative embodiments may omit, add to, reorder, and/or modify any of the acts shown in FIG. 20. In some implementations, the acts of FIG. 20 are performed as part of a method. Alternatively, a non-transitory computer-readable medium can store instructions thereon that, when executed by at least one processor, cause a computing device to perform the acts of FIG. 20. In some embodiments, a system performs the acts of FIG. 20. For example, in one or more embodiments, a system includes at least one processor. The system can further include a non-transitory computer-readable medium comprising instructions that, when executed by the at least one processor, cause the system to perform the acts of FIG. 20.

As shown in FIG. 20, the series of acts 2000 includes an act 2002 of conducting a video call within a participant device. Indeed, the act 2002 can include conducting, by a client device, a video call with a participant device by receiving video data through a video data channel established for the video call from the participant device. Furthermore, as shown in FIG. 20, the series of acts 2000 includes an act 2004 of rendering a video within a three-dimensional augmented reality space. Indeed, the act 2004 can include rendering, within a digital video call interface, a portion of a video captured by a client device within a three-dimensional (3D) augmented reality (AR) space. Moreover, as shown in FIG. 20, the series of acts 2000 includes an act 2006 of transmitting a video stream depicting the three-dimensional augmented reality space to a participant device during the video call. For example, the act 2006 can include transmitting, from a client device, a video stream depicting a 3D AR space to a participant device during a video call.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 21 illustrates a block diagram of an example computing device 2100 (e.g., the server(s) 104, the client devices 108a-108n, the developer device 114, the client device(s) 510, the server(s) 1302, the client devices 1310a-1310n, the server(s) 1602, the client devices 1610a-1610n) that may be configured to perform one or more of the processes described above. One will appreciate that one or more computing devices such as the computing device 2100 may implement the video calling library system 102 (or other systems, such as, the AR video call system 118, the extended-reality transaction system 1306, and/or the audio-based avatar animation system 1606). As shown by FIG. 21, the computing device 2100 can comprise a processor 2102, a memory 2104, a storage device 2106, an I/O interface 2108, and a communication interface 2110, which may be communicatively coupled by way of a communication infrastructure 2112. While an example computing device 2100 is shown in FIG. 21, the components illustrated in FIG. 21 are not intended to be limiting. Additional or alternative components may be used in other embodiments. Furthermore, in certain embodiments, the computing device 2100 can include fewer components than those shown in FIG. 21. Components of the computing device 2100 shown in FIG. 21 will now be described in additional detail.

In one or more embodiments, the processor 2102 includes hardware for executing instructions, such as those making up a computer program. For example, to execute instructions, the processor 2102 may retrieve (or fetch) the instructions from an internal register, an internal cache, the memory 2104, or the storage device 2106 and decode and execute them. In one or more embodiments, the processor 2102 may include one or more internal caches for data, instructions, or addresses. For example, the processor 2102 may include one or more instruction caches, one or more data caches, and one or more translation lookaside buffers (TLBs). Instructions in the instruction caches may be copies of instructions in the memory 2104 or the storage device 2106.

The memory 2104 may be used for storing data, metadata, and programs for execution by the processor(s). The memory 2104 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 2104 may be internal or distributed memory.

The storage device 2106 includes storage for storing data or instructions. For example, storage device 2106 can comprise a non-transitory storage medium described above. The storage device 2106 may include a hard disk drive (HDD), a floppy disk drive, flash memory, an optical disc, a magneto-optical disc, magnetic tape, or a Universal Serial Bus (USB) drive or a combination of two or more of these. The storage device 2106 may include removable or non-removable (or fixed) media, where appropriate. The storage device 2106 may be internal or external to the computing device 2100. In one or more embodiments, the storage device 2106 is non-volatile, solid-state memory. In other embodiments, the storage device 2106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 2108 allows a user to provide input to, receive output from, and otherwise transfer data to and receive data from computing device 2100. The I/O interface 2108 may include a mouse, a keypad or a keyboard, a touch screen, a camera, an optical scanner, network interface, modem, another known I/O devices or a combination of such I/O interfaces. The I/O interface 2108 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 2108 is configured to provide graphical data to a display for presentation to a user. The graphical data may be representative of one or more graphical user interfaces and/or any other graphical content as may serve a particular implementation.

The communication interface 2110 can include hardware, software, or both. In any event, the communication interface 2110 can provide one or more interfaces for communication (e.g., packet-based communication) between the computing device 2100 and one or more other computing devices or networks. For example, the communication interface 2110 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 2110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 2110 may facilitate communications with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination thereof.

Additionally, the communication interface 2110 may facilitate communications across various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 2112 may include hardware, software, or both that connects components of the computing device 2100 to each other. For example, the communication infrastructure 2112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the video calling library system 102 can operate as a social networking system in various embodiments. In addition to the description given above, a social networking system may enable its users (such as persons or organizations) to interact with the system and with each other. The social networking system may, with input from a user, create and store in the social networking system a social media account associated with the user. The social media account may include demographic information, communication-channel information, and information on personal interests of the user. The social networking system may also, with input from a user, create and store a record of relationships of the user with other users of the social networking system, as well as provide services (e.g., wall posts, photo-sharing, online calendars and event organization, messaging, games, or advertisements) to facilitate social interaction between or among users.

Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings.

FIG. 22 illustrates an example network environment 2200 of a networking system. The network environment 2200 includes a social networking system 2202 (e.g., the social networking system 106 which includes the AR video call system 118, the extended-reality transaction system 1306, and/or the audio-based avatar animation system 1606), a user device 2206, and a third-party system 2208 connected to each other by a network 2204. Although FIG. 22 illustrates a particular arrangement of the social networking system 2202, the user device 2206, the third-party system 2208, and the network 2204, this disclosure contemplates any suitable arrangement of the devices, systems, and networks. For example, the user device 2206 and the social networking system 2202 may be physically or logically co-located with each other in whole, or in part. Moreover, although FIG. 22 illustrates a single user device 2206, the social networking system 2202, the third-party system 2208, and the network 2204, this disclosure contemplates any suitable number of devices, systems, and networks.

This disclosure contemplates any suitable network. For example, one or more portions of the network 2204 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 2204 may include one or more networks.

Links may connect the social networking system 2202, the user device 2206, and the third-party system 2208 to the network 2204 or to each other. In particular embodiments, one or more links include one or more wireline (e.g., Digital Subscriber Line (DSL) or Data Over Cable Service Interface Specification (DOCSIS)), wireless (e.g., Wi-Fi or Worldwide Interoperability for Microwave Access (WiMAX)), or optical (e.g., Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 2200. One or more first links may differ in one or more respects from one or more second links.

In particular embodiments, the user device 2206 may be an electronic device including hardware, software, or embedded logic components or a combination of two or more such components and capable of carrying out the appropriate functionalities implemented or supported by the user device 2206. For example, the user device 2206 may include any of the computing devices discussed above in relation to FIG. 21. The user device 2206 may enable a network user to access the network 2204. The user device 2206 may enable its user to communicate with other users associated with other user devices.

In particular embodiments, the user device 2206 may include a web browser, and may have one or more add-ons, plug-ins, or other extensions (e.g., toolbars). A user at the user device 2206 may enter a Uniform Resource Locator (URL) or other address directing the web browser to a particular server (such as server, or a server associated with the third-party system 2208), and the web browser may generate a Hypertext Transfer Protocol (HTTP) request and communicate the HTTP request to server. The server may accept the HTTP request and communicate to the user device 2206 one or more Hypertext Markup Language (HTML) files responsive to the HTTP request.

The user device 2206 may render a webpage based on the HTML files from the server for presentation to the user. For example, webpages may render from HTML files, Extensible Hypertext Markup Language (XHTML) files, or Extensible Markup Language (XML) files, according to particular needs. Such pages may also execute scripts such as those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the social networking system 2202 may be a network-addressable computing system that can host an online network of users (e.g., a social networking system or an electronic messaging system). In some embodiments, such as the illustrated embodiment, the social networking system 2202 implements the video calling library system 102.

The social networking system 2202 may generate, store, receive, and send networking data, such as user-profile data, concept-profile data, graph information (e.g., social-graph information), or other suitable data related to the online network of users. The social networking system 2202 may be accessed by the other components of network environment 2200 either directly or via the network 2204. In particular embodiments, the social networking system 2202 may include one or more servers. Each server may be a unitary server or a distributed server spanning multiple computers or multiple datacenters. Servers may be of various types, such as web server, news server, mail server, message server, advertising server, file server, application server, exchange server, database server, proxy server, another server suitable for performing functions or processes described herein, or any combination thereof.

In one or more embodiments, each server may include hardware, software, or embedded logic components or a combination of two or more such components for carrying out the appropriate functionalities implemented or supported by a server. In particular embodiments, the social networking system 2202 may include one or more data stores. Data stores may be used to store various types of information. In particular embodiments, the information stored in data stores may be organized according to specific data structures. In particular embodiments, each data store may be a relational, columnar, correlation, or another suitable database. Although this disclosure describes or illustrates particular types of databases, this disclosure contemplates any suitable types of databases. Particular embodiments may provide interfaces that enable the social networking system 2202, the user device 2206, or the third-party system 2208 to manage, retrieve, modify, add, or delete, the information stored in a data store.

In particular embodiments, the social networking system 2202 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. The social networking system 2202 may provide users of the online network of users the ability to communicate and interact with other users. In particular embodiments, users may join the online network of users via the social networking system 2202 and then add connections (e.g., relationships) to a number of other users of the social networking system 2202 whom they want to be connected to. Herein, the term “friend” may refer to any other user of the social networking system 2202 with whom a user has formed a connection, association, or relationship via the social networking system 2202.

In particular embodiments, the social networking system 2202 may provide users with the ability to take actions on various types of items or objects, supported by the social networking system 2202. For example, the items and objects may include groups or social networks to which users of the social networking system 2202 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social networking system 2202 or by an external system of the third-party system 2208, which is separate from the social networking system 2202 and coupled to the social networking system 2202 via the network 2204.

In particular embodiments, the social networking system 2202 may be capable of linking a variety of entities. For example, the social networking system 2202 may enable users to interact with each other as well as receive content from the third-party systems 2208 or other entities, or to allow users to interact with these entities through an application programming interfaces (API) or other communication channels.

In particular embodiments, the third-party system 2208 may include one or more types of servers, one or more data stores, one or more interfaces, including but not limited to APIs, one or more web services, one or more content sources, one or more networks, or any other suitable components, e.g., that servers may communicate with. The third-party system 2208 may be operated by a different entity from an entity operating the social networking system 2202. In particular embodiments, however, the social networking system 2202 and the third-party systems 2208 may operate in conjunction with each other to provide social networking services to users of the social networking system 2202 or the third-party systems 2208. In this sense, the social networking system 2202 may provide a platform, or backbone, which other systems, such as the third-party systems 2208, may use to provide social networking services and functionality to users across the Internet.

In particular embodiments, the third-party system 2208 may include a third-party content object provider. A third-party content object provider may include one or more sources of content objects, which may be communicated to a user device 2206. For example, content objects may include information regarding things or activities of interest to the user, such as movie showtimes, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social networking system 2202 also includes user-generated content objects, which may enhance a user's interactions with the social networking system 2202. User-generated content may include anything a user can add, upload, send, or “post” to the social networking system 2202. For example, a user communicates posts to the social networking system 2202 from a user device 2206. Posts may include data such as status updates or other textual data, location information, photos, videos, links, music or other similar data or media. Content may also be added to the social networking system 2202 by a third-party through a “communication channel,” such as a newsfeed or stream.

In particular embodiments, the social networking system 2202 may include a variety of servers, sub-systems, programs, modules, logs, and data stores. In particular embodiments, the social networking system 2202 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social networking system 2202 may also include suitable components such as network interfaces, security mechanisms, load balancers, failover servers, management-and-network-operations consoles, other suitable components, or any suitable combination thereof. In particular embodiments, the social networking system 2202 may include one or more user-profile stores for storing social media accounts.

A social media account may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. For example, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes.

The connection information may also include user-defined connections between different users and content (both internal and external). A web server may be used for linking the social networking system 2202 to one or more user device 2206 or one or more the third-party system 2208 via the network 2204. The web server may include a mail server or other messaging functionality for receiving and routing messages between the social networking system 2202 and one or more user device 2206. An API-request server may allow the third-party system 2208 to access information from the social networking system 2202 by calling one or more APIs. An action logger may be used to receive communications from a web server about a user's actions on or off social networking system 2202. In conjunction with the action log, a third-party-content-object log may be maintained of user exposures to third-party-content objects. A notification controller may provide information regarding content objects to a user device 2206.

Information may be pushed to a user device 2206 as notifications, or information may be pulled from user device 2206 responsive to a request received from user device 2206. Authorization servers may be used to enforce one or more privacy settings of the users of the social networking system 2202. A privacy setting of a user determines how particular information associated with a user can be shared. The authorization server may allow users to opt in to or opt out of having their actions logged by the social networking system 2202 or shared with other systems (e.g., the third-party system 2208), such as by setting appropriate privacy settings. Third-party-content-object stores may be used to store content objects received from third parties, such as the third-party system 2208. Location stores may be used for storing location information received from user device 2206 associated with users. Advertisement-pricing modules may combine social information, the current time, location information, or other suitable information to provide relevant advertisements, in the form of notifications, to a user.

FIG. 23 illustrates example social graph 2300. In particular embodiments, the social networking system 2202 may store one or more social graphs 2300 in one or more data stores. In particular embodiments, social graph 2300 may include multiple nodes—which may include multiple user nodes 2302 or multiple concept nodes 2304—and multiple edges 2306 connecting the nodes. Example social graph 2300 illustrated in FIG. 23 is shown, for didactic purposes, in a two-dimensional visual map representation. In particular embodiments, the social networking system 2202, the user device 2206, or the third-party system 2208 may access social graph 2300 and related social-graph information for suitable applications. The nodes and edges of social graph 2300 may be stored as data objects, for example, in a data store (such as a social-graph database). Such a data store may include one or more searchable or quarriable indexes of nodes or edges of social graph 2300.

In particular embodiments, a user node 2302 may correspond to a user of the social networking system 2202. For example, a user may be an individual (human user), an entity (e.g., an enterprise, business, or third-party application), or a group (e.g., of individuals or entities) that interacts or communicates with or over social networking system 2202. In particular embodiments, when a user registers for an account with the social networking system 2202, the social networking system 2202 may create a user node 2302 corresponding to the user and store the user node 2302 in one or more data stores. Users and user nodes 2302 described herein may, where appropriate, refer to registered users and user nodes 2302 associated with registered users.

In addition, or as an alternative, users and user nodes 2302 described herein may, where appropriate, refer to users that have not registered with the social networking system 2202. In particular embodiments, a user node 2302 may be associated with information provided by a user or information gathered by various systems, including the social networking system 2202. For example, a user may provide his or her name, profile picture, contact information, birth date, sex, marital status, family status, employment, education background, preferences, interests, or other demographic information. Each user node of the social graph may have a corresponding web page (typically known as a profile page). In response to a request including a username, the social networking system can access a user node corresponding to the username, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 2304 may correspond to a concept. For example, a concept may correspond to a place (e.g., a movie theater, restaurant, landmark, or city); a website (e.g., a website associated with social networking system 2202 or a third-party website associated with a web-application server); an entity (e.g., a person, business, group, sports team, or celebrity); a resource (e.g., an audio file, video file, digital photo, text file, structured document, or application) which may be located within the social networking system 2202 or on an external server, such as a web-application server; real or intellectual property (e.g., a sculpture, painting, movie, game, song, idea, photograph, or written work); a game; an activity; an idea or theory; another suitable concept; or two or more such concepts. A concept node 2304 may be associated with information of a concept provided by a user or information gathered by various systems, including the social networking system 2202. For example, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2304 may be associated with one or more data objects corresponding to information associated with concept node 2304. In particular embodiments, a concept node 2304 may correspond to one or more webpages.

In particular embodiments, a node in the social graph 2300 may represent or be represented by a webpage (which may be referred to as a “profile page”). Profile pages may be hosted by or accessible to the social networking system 2202. Profile pages may also be hosted on third-party websites associated with a third-party system 2208. For example, a profile page corresponding to a particular external webpage may be the particular external webpage, and the profile page may correspond to a particular concept node 2304. Profile pages may be viewable by all or a selected subset of other users. For example, a user node 2302 may have a corresponding user-profile page in which the corresponding user may add content, make declarations, or otherwise express himself or herself. As another example and not by way of limitation, a concept node 2304 may have a corresponding concept-profile page in which one or more users may add content, make declarations, or express themselves, particularly in relation to the concept corresponding to concept node 2304.

In particular embodiments, a concept node 2304 may represent a third-party webpage or resource hosted by the third-party system 2208. The third-party webpage or resource may include, among other elements, content, a selectable or another icon, or another inter-actable object (which may be implemented, for example, in JavaScript, AJAX, or PHP codes) representing an action or activity. For example, a third-party webpage may include a selectable icon such as “like,” “check-in,” “eat,” “recommend,” or another suitable action or activity. A user viewing the third-party webpage may perform an action by selecting one of the icons (e.g., “eat”), causing a user device 2206 to send to the social networking system 2202 a message indicating the user's action. In response to the message, the social networking system 2202 may create an edge (e.g., an “eat” edge) between a user node 2302 corresponding to the user and a concept node 2304 corresponding to the third-party webpage or resource and store edge 2306 in one or more data stores.

In particular embodiments, a pair of nodes in the social graph 2300 may be connected to each other by one or more edges 2306. An edge 2306 connecting a pair of nodes may represent a relationship between the pair of nodes. In particular embodiments, an edge 2306 may include or represent one or more data objects or attributes corresponding to the relationship between a pair of nodes. For example, a first user may indicate that a second user is a “friend” of the first user. In response to this indication, the social networking system 2202 may send a “friend request” to the second user.

If the second user confirms the “friend request,” social networking system 2202 may create an edge 2306 connecting the first user's user node 2302 to the second user's user node 2302 in the social graph 2300 and store edge 2306 as social-graph information in one or more of data stores. In the example of FIG. 23, social graph 2300 includes an edge 2306 indicating a friend relation between user nodes 2302 of user “A” and user “B” and an edge indicating a friend relation between user nodes 2302 of user “C” and user “B.” Although this disclosure describes or illustrates particular edges 2306 with particular attributes connecting particular user nodes 2302, this disclosure contemplates any suitable edges 2306 with any suitable attributes connecting user nodes 2302. For example, an edge 2306 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 2300 by one or more edges 2306.

In particular embodiments, an edge 2306 between a user node 2302 and a concept node 2304 may represent a particular action or activity performed by a user associated with user node 2302 toward a concept associated with a concept node 2304. For example, as illustrated in FIG. 23, a user may “like,” “attended,” “played,” “listened,” “cooked,” “worked at,” or “watched” a concept, each of which may correspond to an edge type or subtype. A concept-profile page corresponding to a concept node 2304 may include, for example, a selectable “check-in” icon (e.g., a clickable “check-in” icon) or a selectable “add to favorites” icon. Similarly, after a user clicks these icons, the social networking system 2202 may create a “favorite” edge or a “check-in” edge in response to a user's action corresponding to a respective action.

As another example and not by way of limitation, a user (user “C”) may listen to a particular song (“Ramble On”) using a particular application (e.g., an online music application). In this case, the social networking system 2202 may create a “listened” edge 2306 and a “used” edge (as illustrated in FIG. 23) between user nodes 2302 corresponding to the user and concept nodes 2304 corresponding to the song and application to indicate that the user listened to the song and used the application.

Moreover, the social networking system 2202 may create a “played” edge 2306 (as illustrated in FIG. 23) between concept nodes 2304 corresponding to the song and the application to indicate that the particular song was played by the particular application. In this case, “played” edge 2306 corresponds to an action performed by an external application on an external audio file (the song “Song Title”). Although this disclosure describes particular edges 2306 with particular attributes connecting user nodes 2302 and concept nodes 2304, this disclosure contemplates any suitable edges 2306 with any suitable attributes connecting user nodes 2302 and concept nodes 2304.

Furthermore, although this disclosure describes edges between a user node 2302 and a concept node 2304 representing a single relationship, this disclosure contemplates edges between a user node 2302 and a concept node 2304 representing one or more relationships. For example, an edge 2306 may represent both that a user likes and has used at a particular concept. Alternatively, another edge 2306 may represent each type of relationship (or multiples of a single relationship) between a user node 2302 and a concept node 2304 (as illustrated in FIG. 23 between user node 2302 for user “E” and concept node 2304 for the online music application.

In particular embodiments, the social networking system 2202 may create an edge 2306 between a user node 2302 and a concept node 2304 in the social graph 2300. For example, a user viewing a concept-profile page (e.g., by using a web browser or a special-purpose application hosted by the user's user device 2206) may indicate that he or she likes the concept represented by the concept node 2304 by clicking or selecting a “Like” icon, which may cause the user's user device 2206 to send to the social networking system 2202 a message indicating the user's liking of the concept associated with the concept-profile page.

In response to the message, the social networking system 2202 may create an edge 2306 between user node 2302 associated with the user and concept node 2304, as illustrated by “like” edge 2306 between the user and concept node 2304. In particular embodiments, the social networking system 2202 may store an edge 2306 in one or more data stores. In particular embodiments, an edge 2306 may be automatically formed by the social networking system 2202 in response to a particular user action. For example, if a first user uploads a picture, watches a movie, or listens to a song, an edge 2306 may be formed between user node 2302 corresponding to the first user and concept nodes 2304 corresponding to those concepts. Although this disclosure describes forming particular edges 2306 in particular manners, this disclosure contemplates forming any suitable edges 2306 in any suitable manner.

In particular embodiments, an advertisement may be text (which may be HTML-linked), one or more images (which may be HTML-linked), one or more videos, audio, one or more FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on the social networking system 2202)

A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a predetermined area of a profile page of a user or other page, presented with additional information associated with the advertiser, bumped up or otherwise highlighted within news feeds or tickers of other users, or otherwise promoted. The advertiser may pay to have the social action promoted. For example, advertisements may be included among the search results of a search-results page, where sponsored content is promoted over non-sponsored content.

In particular embodiments, an advertisement may be requested for display within social networking system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. For example, the user may view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, the social networking system 2202 may execute or modify a particular action of the user.

An advertisement may also include social networking-system functionality that a user may interact with. For example, an advertisement may enable a user to “like” or otherwise endorse the advertisement by selecting an icon or link associated with the endorsement. As another example and not by way of limitation, an advertisement may enable a user to search (e.g., by executing a query) for content related to the advertiser. Similarly, a user may share the advertisement with another user (e.g., through the social networking system 2202) or RSVP (e.g., through the social networking system 2202) to an event associated with the advertisement. In addition, or as an alternative, an advertisement may include a social networking system context directed to the user. For example, an advertisement may display information about a friend of the user within the social networking system 2202 who has taken an action associated with the subject matter of the advertisement.

In particular embodiments, the social networking system 2202 may determine the social-graph affinity (which may be referred to herein as “affinity”) of various social-graph entities for each other. Affinity may represent the strength of a relationship or level of interest between particular objects associated with the online network of users, such as users, concepts, content, actions, advertisements, other objects associated with the online network of users, or any suitable combination thereof. Affinity may also be determined with respect to objects associated with the third-party systems 2208 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social networking system 2202 may measure or quantify social-graph affinity using an affinity coefficient (which may be referred to herein as “coefficient”). The coefficient may represent or quantify the strength of a relationship between particular objects associated with the online network of users. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online network of users. For example, these actions may include various types of communications, such as sending messages, posting content, or commenting on content; various types of an observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social networking system 2202 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static, or the weights may change according to, for example, the user, the type of relationship, the type of action, the user's location, and so forth. Ratings for the factors may be combined according to their weights to determine an overall coefficient for the user. For example, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 2202 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. For example, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social networking system 2202 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social networking system 2202 may calculate a coefficient based on a user's actions. The social networking system 2202 may monitor such actions on the online network of users, on the third-party system 2208, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, the social networking system 2202 may calculate a coefficient based on the user's actions with particular types of content. The content may be associated with the online network of users, the third-party system 2208, or another suitable system. The content may include users, profile pages, posts, news stories, headlines, instant messages, chat room conversations, emails, advertisements, pictures, video, music, other suitable objects, or any combination thereof. The social networking system 2202 may analyze a user's actions to determine whether one or more of the actions indicate an affinity for the subject matter, content, other users, and so forth. For example, if a user may make frequently posts content related to “coffee” or variants thereof, the social networking system 2202 may determine the user has a high coefficient with respect to the concept “coffee.” Particular actions or types of actions may be assigned a higher weight and/or rating than other actions, which may affect the overall calculated coefficient. For example, if a first user emails a second user, the weight or the rating for the action may be higher than if the first user views the user-profile page for the second user.

In particular embodiments, the social networking system 2202 may calculate a coefficient based on the type of relationship between particular objects. Referencing the social graph 2300, the social networking system 2202 may analyze the number and/or type of edges 2306 connecting particular user nodes 2302 and concept nodes 2304 when calculating a coefficient. For example, user nodes 2302 that are connected by a spouse-type edge (representing that the two users are married) may be assigned a higher coefficient than user nodes 2302 that are connected by a friend-type edge. In other words, depending upon the weights assigned to the actions and relationships for the particular user, the overall affinity may be determined to be higher for content about the user's spouse than for content about the user's friend.

In particular embodiments, the relationships a user has with another object may affect the weights and/or the ratings of the user's actions with respect to calculating the coefficient for that object. For example, if a user is tagged in a first photo, but merely likes a second photo, the social networking system 2202 may determine that the user has a higher coefficient with respect to the first photo than the second photo because having a tagged-in-type relationship with content may be assigned a higher weight and/or rating than having a like-type relationship with content.

In some embodiments, the social networking system 2202 may calculate a coefficient for a first user based on the relationship one or more second users have with a particular object. In other words, the connections and coefficients other users have with an object may affect the first user's coefficient for the object. For example, if a first user is connected to or has a high coefficient for one or more second users, and those second users are connected to or have a high coefficient for a particular object, the social networking system 2202 may determine that the first user should also have a relatively high coefficient for the particular object.

In one or more embodiments, the coefficient may be based on the degree of separation between particular objects. The degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.”

Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 2300. For example, social-graph entities that are closer in the social graph 2300 (i.e., fewer degrees of separation) may have a higher coefficient than entities that are further apart in the social graph 2300.

In particular embodiments, the social networking system 2202 may calculate a coefficient based on location information. Objects that are geographically closer to each other may be considered to be more related, or of more interest, to each other than more distant objects. In some embodiments, the coefficient of a user towards a particular object may be based on the proximity of the object's location to a current location associated with the user (or the location of a user device 2206 of the user). A first user may be more interested in other users or concepts that are closer to the first user. For example, if a user is one mile from an airport and two miles from a gas station, the social networking system 2202 may determine that the user has a higher coefficient for the airport than the gas station based on the proximity of the airport to the user.

In particular embodiments, the social networking system 2202 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social networking system 2202 may provide information that is relevant to a user's interests and current circumstances, increasing the likelihood that they will find such information of interest.

In some embodiments, the social networking system 2202 may generate content based on coefficient information. Content objects may be provided or selected based on coefficients specific to a user. For example, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object.

In one or more embodiments, the social networking system 2202 may generate search results based on coefficient information. The search results for a particular user may be scored or ranked based on the coefficient associated with the search results with respect to the querying user. For example, search results corresponding to objects with higher coefficients may be ranked higher on a search-results page than results corresponding to objects having lower coefficients.

In particular embodiments, the social networking system 2202 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online network of users, from the third-party system 2208 (e.g., via an API or another communication channel), or from another suitable system. In response to the request, the social networking system 2202 may calculate the coefficient (or access the coefficient information if it has previously been calculated and stored).

In various embodiments, the social networking system 2202 may measure an affinity with respect to a particular process. Different processes (both internal and external to the online network of users) may request a coefficient for a particular object or set of objects. The social networking system 2202 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed Aug. 11, 2006, U.S. patent application Ser. No. 12/977,027, filed Dec. 22, 2010, U.S. patent application Ser. No. 12/978,265, filed Dec. 23, 2010, and U.S. patent application Ser. No. 13/632,869, filed Oct. 1, 2012, each of which is incorporated by reference in their entirety.

In particular embodiments, one or more of the content objects of the online network of users may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online network of users. Where the privacy settings for an object allow a particular user to access that object, the object may be described as being “visible” with respect to that user. For example, a user of the online network of users may specify privacy settings for a user-profile page identify a set of users that may access the work experience information on the user-profile page, thus excluding other users from accessing the information.

In particular embodiments, the privacy settings may specify a “blocked list” of users that should not be allowed to access certain information associated with the object. In other words, the blocked list may specify one or more users or entities for which an object is not visible. For example, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online network of users. For example, a particular concept node 2304 corresponding to a particular photo may have a privacy setting specifying that the photo may only be accessed by users tagged in the photo and their friends.

In particular embodiments, privacy settings may allow users to opt in or opt out of having their actions logged by the social networking system 2202 or shared with other systems (e.g., the third-party system 2208). In particular embodiments, the privacy settings associated with an object may specify any suitable granularity of permitted access or denial of access. For example, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of the third-party systems 2208, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, the social networking system 2202 may send a request to the data store for the object. The request may identify the user associated with the request and may only be sent to the user (or a user device 2206 of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user.

In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
establishing, by at least one processor, a video call with a recipient client device;
identifying, by the at least one processor, a viseme from audio data captured during the video call; and
generating, by the at least one processor, an animated avatar for the video call utilizing the identified viseme.

2. A non-transitory computer-readable medium storing instructions that, when executed by at least one processor, cause a computing device to:
store, at a video calling server, a video calling application library comprising a set of encoded core video calling functions compatible across a plurality of video calling applications and video calling platforms;
receive a request for generating a video calling application comprising the set of encoded core video calling functions and one or more additional video calling functions;
generate the video calling application to include the set of encoded core video calling functions and the one or more additional video calling functions; and
provide the video calling application to a client device in response to a download request.

3. The non-transitory computer-readable medium of claim 2, further comprising instructions that, when executed by the at least one processor, cause the computing device to enable the client device to:
conduct, by the client device, a video call with a participant device by receiving video data through a video data channel established for the video call from the participant device;
render, within a digital video call interface, a portion of a video captured by the client device within a three-dimensional (3D) augmented reality (AR) space; and
transmit, from the client device, a video stream depicting the 3D AR space to the participant device during the video call.

4. A system comprising:
at least one processor; and
at least one non-transitory computer-readable medium comprising instructions that, when executed by the at least one processor, cause the system to:
detect a user interaction with an object within an extended-reality environment from a first client device;
establish a voice channel between the first client device and a second client device associated with the object from the extended-reality environment while the first client device presents the extended-reality environment; and
facilitate a payment transaction between the first client device and the second client device through the voice channel for a product represented by the object within the extended-reality environment while the first client device presents the extended-reality environment.
